(19) United States
(12) Patent Application Publication
(10) Pub. No.: US 2006/0238503 A1
(43) Pub. Date: Oct. 26, 2006

(54) Deputy series-music cinema or transfortainment PC (phirst classic) or Digi-Tasking Mobile-Cycle devices for maximum digital mobilosity or the digital entertaining PC or the all digital activity center or satellite entertainment mogul or satellite entertainment PC (phirst classic)

(76) Inventors: Jerome William Smith, Oakland, CA (US); La Tretha Ellonise Stroughter, Antioch, CA (US)

Correspondence Address: Jerome W. Smith, 2839-61st Avenue, Oakland, CA, 94605, US

(21) Appl. No.: 11/410,423

(22) Filed: Apr. 22, 2006

Related U.S. Application Data
(63) Continuation-in-part of application No. 11/227,546, now abandoned.
(60) Provisional application No. 60/611,149, filed on Sep. 18, 2004.

(51) Int. Cl. G09G 5/00

(52) U.S. Cl. 345/156

(57) ABSTRACT

Deputy Series-Music Cinema et. al. Is a televisual/satellite, mass production and communications system. Coliseum Screens are maximized in mobility as a part of our “Digi-Tasking-Mobile-Cycle”. The Coliseum Screens are two wireless/cordless detachable television/computer monitors. Multiple style tooth ray enhancements along with media to media digital interface transfer. The Arsenal Tower will generate all components. Coliseum Screens/Television monitors will reach trillions in satellite cable style interface. Equipped with scrambler/de-scrambler-tracking capabilities. All keyboards will support functions that appear on Coliseum Screens. Dust Shield Wiper capabilities for screen cleaning. My Flavorite Pen enables writing in mid air through laser to laser enhancements.

### RELATED APPLICATIONS

The present application is a continuation application of U.S. provisional patent application, Ser. No. 60/611,149, filed Sep. 18, 2004, for DEPUTY SERIES—MUSIC CINEMA, by Jerome W. Smith, La Tretha E. Stroughter, included by reference herein and for which benefit of the priority date is hereby claimed.

The present application is a continuation application of U.S. provisional patent application, Ser. No. US 60/611,149, filed Oct. 23, 2004, for DEPUTY SERIES—MUSIC CINEMA, by Jerome W. Smith, La Tretha E. Stroughter, included by reference herein and for which benefit of the priority date is hereby claimed.

The present application is a continuation-in-part application of U.S. patent application, Ser. No. 11/227,546, filed Sep. 15, 2005, for DEPUTY SERIES—MUSIC CINEMA, by Jerome W. Smith, La Tretha E. Stroughter, included by reference herein and for which benefit of the priority date is hereby claimed.

The present application is a continuation-in-part application of U.S. patent application, Ser. No. 11/227,546, filed Sep. 30, 2005, for DEPUTY SERIES—MUSIC CINEMA, by Jerome W. Smith, La Tretha E. Stroughter, included by reference herein and for which benefit of the priority date is hereby claimed.

Please Note these are additional statements

We just want to place this note for the record that our invention by Jerome W. Smith and La Tretha E. Stroughter was created on Jan. 2, 1997 through 2003. Inventor(S) Note: Before coming up with this magnificent new way for Transfortainment (Transfortainment means to have multiple applications of digital media, satellite entertainment conversions and also many different ways to transfer, transform, view and listen to a wide variety of mass media and communications), there was nothing even remotely close to what we have in our possession. In the year between 1997 to 1998 we did a lot of entrepreneurial style marketing, beating the pavement and knocking on many many doors. Everyone laughed at us or didn't return our calls or very few little responses, or stated to us that we were before our time, but of course we knew that. Between the year of 1999 through 2000 some of our key scientist and top mogul representatives around the globe were beginning to come out the gate with futuristic introspections or comments of what could happen in the future based on our many concepts, applications and theories of this magnitude on which we witness today. At that time we were still ahead of the class and before our time. Between 2001 and 2002 we were constantly researching and getting new information that our evolution could be made possible in years to come. Between the year 2003 and 2004 we have changed the market, raise the bar significantly and combined companies in unity that never thought they would ever work together in unity to accomplish a set of goals. What we have created have opened doors for massive new job markets and new businesses. In performing these tasks our goals are to where new inventors would no longer have it so hard to get in touch with and/or present themselves and their projects to big firms or CEO's on the high technological circuit. During our research we have found that a number of high technological companies have open their doors and now welcome the opportunity for outside inventors to submit their ideas, as to where before it was next to impossible to be able to submit an idea from the outside world without being an employee such as an internal scientist. Through our research, marketing strategies, discipline, constant persistence, the need to know, being aware of all sorts of criticism(s), being able to overcome various obstacles. For example: “There's no interest” “There's no opportunity at this time” “It's an excellent invention but whose going to build it?” or “This excellent invention can be built but what our firm needs to know, who are the other money players at the round table besides our interest. “You two won't make it without a partner!” “You two may need a partner but of course there's always something behind door number 3”. You name it, we've heard it, and still we have stayed focused. We look at it this way, this is something that we were born with and born to do. We started inventing little things in our early childhood. So inventing comes natural to the both of us. We just want the world to be exposed to our focus and be able to create new technology for years to come because we have several new inventions to last for generations to come and we're very grateful to be a part of these evolutionary changes. System Note: Scientist, researchers and/or, analyst that create new language to ensure hardware of the Deputy Series et. al will run correctly, will complete the integrated Software. Reminder: System can be used as a multi-multi screen as well as a massive high speed digital cable connection to attract trillions and trillions in service. The system can be used with or without keyboard, joystick, driving wheel and/or mouse. The mouse can be RemotoMouse/Retractable Keyboard Remote, that's remotely driven as well as voice activated. Access Mobility Pilot which means (A different and enhanced form of ADA programming) will allow activities to be performed, depending on the impairment. Improvements using already existing products as well as new technology from today's as well as futuristic assembly lines. Systems will be available such as our Digi-Tasking-Mobile Cycle Devices. D.T.M.C.D. means simply an individual's desire and expression of how they want their own mobility device customized. For example starting with our palm to palm held mobile devices, the wrist top, the thigh pad system (Is an individual's D.T.M.C.D. that sits comfortably around thigh with two velcro style blood pressure bands, that attaches together, one size fits all). These applications are great for maximum mobilosity as well as a multiple host of others in the near future.

### FIELD OF THE INVENTION

The present invention relates to Digital Media Interfaces, Communications and all Mobile enhancements . . . and, more particularly, to . . . a more simpler human friendly style Digital Entertaining Computer Activity System. We are the original conceivers of these ideas and invention concepts all carefully master planned and illustrated on Jan. 2, 1997-2003. Please note: This invention is designed to improve or upgrade an existing technology or product. This system is designed to where there are multi versatile conceptions and connections such as specialty box connections, along with special service connections to super enhance this enriched performance level television. This system is designed with multiple internal features to work along with other televisions/audio and media hardware in designated areas, as well as on the go for a maximum mobility.

### BACKGROUND OF THE INVENTION

Ever since computing implements (e.g. Computer and Appliances) were invented there has been accessive curiosity and a dire need for entertaining style enhancement and implementing. Safely in the order that this new level of implementing would change the way we would use this computing style application forever. Through global formatting and outer space utilities, media/communication transmissions, now, this will be made possible.

Television remote control—Novitski, Feb. 24, 1976 U.S. Pat. No. 3,940,701

Television computer keyboard Goodin et. al.—Sep. 20, 1983 U.S. Pat. No. D,270,639

Computer Monitor The mouse—Mori—Jun. 28, 1988 U.S. Pat. No. 4,754,268

Computer Terminal—Goodman—Jul. 27, 1982 U.S. Pat. No. 4,342,095

Speaker System-Butler—Jan. 20, 1976 U.S. Pat. No. 3,933,219

Our invention will create new technology and improve or upgrade an existing technology or products.

It is therefore an object of the invention to digitally showcase multiple interfaces of the fully functional, reversible, detachable, televisual Coliseum Screens that's motivationally connected by four fiber glass, ½ mm studs along with four 1 mm universal grooves for snug fit between screens. Involving crisp fiber optic streamline circuitry with multi camera probes neatly in place, enhancing unbelievable pixel style capabilities and graphic arrays. Experimenting with multi colored image signaling and soft beams of multi lighting for the sharpest multiple visual dot style synchronizing possible.

It is another object of the invention to digitally cross interface the terminal with multiple server and digital cable style attributes (either flat style, box style or standard upright in positioning). This tower is completely reversible and built to mount on Deputy Series Storage Unit

which is on four dicast rollers for constant motion and mobility. Allowing all means of media/communications between Satellite/GPS

responses to go hand in hand with fiber optic style multi conductor units here on earth.

It is another object of the invention to illuminate the entire system through the Satellite Launch Pad Keyboard or Retractable Functional

Keypad both allowing individuals multi medical access through the Index Scan Device. Also allowing mass conversion of all

medical collaborations, terminology, communications, billings, visual, dental and medical, transportation you name it, the Index Scan Device

along with all other services will prevail. This is just another multiple key wonder through multiple functions.

### SUMMARY OF THE INVENTION

In accordance with the present invention, We the inventors designed this system for the globe. It's programmed to access unbelievable pixel style capabilities, multi ray interface, in gaming also in video maneuvers such as video games and video gambling. It will be programmed also to save commercials and reruns on multi drives for immediate digital transfer. Manual capabilities will allow individuals to move pictures or entire subjects by erasing screen by hand through enhanced pixel style operations. For example: Our Transfer Touch Feature, will allow individuals to record music, movies, jam sessions, drama courses, low/high budget video shoots, short movies, upload or download to system for transferable activities to agent/production companies or music producers at one time on many different channels. There will be unlimited selections to choose from while watching one, two or multiple televisual devices, also playing games on different style “Coliseum” Screens. Coliseum Screens/Television monitors will be able to reach mega-millions in channels. Equipped with scrambler/de-scrambler-tracking capabilities. Coliseum Screens are maximized in mobility as a part of our “Digi-Tasking-Mobile-Cycle”. Another special feature of the Deputy Series et. al. is the The Mini Spectrum Port Holes Function allowing individuals to bring up different catagories such as; pictures, music, communcations, translations etc. all on Coliseum Screens, in many different sizes and shapes, and move them around like you would in a solitaire style card game. You can make them disappear choose from a library of previous uploads and downloads etc.

The Coliseum Screens are two wireless/cordless detachable television/computer monitors or other Coliseum Screens can also be used to surround them for multiple viewing. These devices are now easily transported to patio, next room or taken on a road trip or in/on or about any vehicle and easily put into vacation mode for messages or communication. System is equipped with “Anglelator” (which means this function allows you to see movies and all video gaming from every angle and close up viewing etc,) this function will put you almost in the movie. Panoramic universal sound capabilities and many high frequencies to choose from. Multiple designer screens. From law enforcement to military to business seminars, showing statistics, introductions, and study labs you name it, this machine will be the one to watch. All Coliseum Screens have extreme fold down capabilities. Retractable Functional Keypad is equipped with a voice activated speed writer/fax/copies/scan style operations, all wireless/cordless at a touch of a button on your Retractable Functional Keypad control, wireless phone/landline/cell phone style capabilities. Movies transfer upload/download from any outside system, such as relative or next-door neighbor, burn CD's etc., with the help of Satellite/GPS on demand style linkage as we mentioned previously. Unlimited server capabilities or we would like to call it “The Butler” capabilities, because of it's strength and serves higher frequency demand capabilities, now enhancing major synchronized areas to record multiple functions onto multiple drives. The system is equipped with internal high power satellite chipsets (GPS either inside TV/Computer Monitor/Keyboard or Terminal) System is equipped with universal sound and mixing portability, allows you to download and upload phone/cell configurations music or voice recording or create your own personal tones and configurations. GPS or laser transmitters allow our machine to be with cords or without. There are advance server applications that can be used along with our Arsenal Tower. This system has a device that is voice activated with planner-reminders, date book-diaries all integrated into Coliseum Screens, all generated from system Arsenal Tower components. Another interesting function will be the Virtual Aqua Display that consists of aquariums actually mounted in the tower or server safely. This feature has a cross over of actual tropical fish or landscaping/plant life with the virtual assistance of a all digital array in back drop. This system will be programmed where you may watch “Night Watch Man” surveillance cams. To name a few options on this series that's set up for all areas of desire and still look in on your favorite TV shows, videos and record music at the same time. The Night Watch Man allows users to internally and externally look in on neighborhood activities. Individuals will be able to lock in on suspicious characters crouching down between two vehicles, suspicious activities in dark alley ways near your home, someone lurking up and down the street after hours. This device will allow you to look inside of a parked car, also under the car and around it or a moving car going down the block. Through our mobile cycling device, these same functions and sequences that are mentioned above can be done by this mobile unit while you're away from home to check on activities surrounding your home while you're away as well as before you return to enter your home to make sure it's safe. Other activities will include everything from a cat stuck in a tree to birdwatching etc. System includes mulitple size viewing preferences, Multiple levels of distinct translations. System will allow you to capture still shots and film family reunions while watching any sport or programs, thanks to modem enhancement as well as Satellite and GPS by demand. Record playbacks, snapshots, freeze, still shots on one or multiple “Coliseum Screens”. Because of the seriousness of the series this system will be equipped with all digital media/multiple communication functions for example: CB Radio/Walkie Talkie/AM-FM Radio Style linkage/911 Power emergency/Police Mobile Style Scanners. 5 to 500 tier multiple burner style features for a wide variety of media, interfaces, all performed through satellite/GPS Enhancement. Pull out mobilosity games/Pull out Transformation card system. The system's Satellite Launch Pad Keyboard is equipped with clip on device for Index Scan based on keyboard as well as all wireless, that takes heart rate, blood pressure, asthma statistics, temperature, pulse rate, weight, gives calorie statistics, Cholesterol readings, Blood Sugar testing, Breath-alizer, programmed also with every humanly medical testing possible done state of the art. This system will allow patients, clients or physicians to get information over system from home or office or around the globe. Patients will be able to email or fax statistics to physician and will be able to get more than one opinion at the same time with multiple physicians on serious health and medical conditions by using multi-line digital communications. Through these digital enhancements, patients will be able to access and update medical records electronically at home and at medical facilities. Server has storage cabinet and storage compartments for total hardware capacities. This system will feature a very affordable price for all. System is equipped with Access Mobility Pilot functions; sign language reader/translator, Braille can be on screen as well as on keyboard (optional) hearing devices, joysticks etc. This system will be a whole new Indigimation/Digitainment way of life. Access Mobility Pilot accessible (meaning special features and functions for the disabled community). This will all be made up from pre-existing computer structures and technology along with some technology not yet developed. The Remotomouse remote control. The Remotomouse opens to expose the remote control features. Wireless attributes of media/communication for example: its universal and can be used for personal stereos, air conditioning, heater systems, setting alarms, handheld calculator, voice activation, LCD/LED style reminders/click n check capabilities, which gives you the access to push and hold button on the mouse to reveal all of your appointment reminders, voice notes, instant fax, text messaging, calendar, and able to load personal TV Roster Information, surveillance and flash style lighting all by sensor and infrared style signaling. The Remotomouse illuminates just like the entire system and will work in extreme darkness. At one touch of a button screen can be adjusted for your eyes. A touch of button and the entire machine lights up for the graveyard shift sort of speak. Speaker system—T.W.I.N. Coustic Speakers, Dolby, EQ super bass, air purifier-3 speed fan, air freshener/conditioner. Sound acoustics built in. Retractable Functional KeyPad keys contains what we call new school/old school satellite keys, for example: 15 buttons featuring pause, play button, laser sensor, intercom, keyboard swivel action as well as adjustable integration for comfort, speed writer, fax-copier-scanner-telephone (earphone, laser transmission). Please don't forget that this machine is a series of upgrades, major concepts and applications, add a little here, add a little there. This system is in a class of its own. PDA style media functions along with many others, now performed through chipset and globally conducted, digital sensoring and satellite response it's just that simple. All ports for media/communication interfacing will be digital/wireless. All Wireless integrated style scanner, floppy disc, all drive slots, 8mm cameras, cellphone ports, cordless headphone transmission, for example: allowing you to hear news, movies and ball games while you mow the lawn, ports for laser disc, twin or multiple turntables with mixer transferred into system. For example: The Arsenal Tower also has plug in sockets for electric shaver, small cold water dispenser, micro coffeepot, and mini microwave, compact paper shreddar, cold storage for beverages etc. This will be a futuristic description of screens for the future of the series. The Coliseum Screen 1 is called the “Coliseum” universal screen. Photo Cam, Photo Probes, Movie Cam, Overhead style projection capabilities, all digital, all top center screen. Voice middle button screen 1 can be doubled up with back to back screening. Detachable for car, meetings, gatherings for total mobility. Coliseum Screens range from a 15 foot Screen to our smaller motivational systems that we introduce as the Digi-Tasking-Mobile Cycling devices. These devices range from stick pin size to palm to palm held to rice paper thin to wrist top, to our thigh pad system, along with an assorted range of others varying in all Flavor colors, shapes, forms and sizes. These are extra styles and functions of the Coliseum Screen format. Introducing the Hollywood Split Screen that demonstrates 32 pictures or better with highlighted colors, mix stations or same channels at the same time. System is equipped with projector and video ports on tower/terminal/console. System allows recording on multiple Coliseum Screens at once. This screen is back to back and flips open by hinges. All screens come with slide screen cover (this cover shades the brightness of the screen for protection of the eyes and standards with ergonomics, also protection of the screens). Screens also come with the worlds first “Dust shield Wiper” (a windshield wiper blade style effect for cleaning of screens) top or bottom, detachable/attchable to screen base (optional). Spray and dry mist, the wipers do it all. System can convert screen to a dry erase white board for the Digital Projection Grid formatting. This system can write and erase with “My Flavorite Pen” or by laser writing without ever touching the screen. Grav-Draulics works at a touch of a button with multiple speeds. The Grav-Draulic Pod feature manuevers consists of front and back sway bar, sway bar axis-Protractor and slide hydraulic multi level base. The Coliseum Screens turn full circle up & down, bend back and forth, slide side to side. Screen 1 comes with detachable stand clip for self mounting anywhere (optional). Our Grav-Draulic stand for our screens has multiple screen beds and other interior decorations for other flat screens and will be controlled by the Satellite Launch Pad Keyboard, Remotomouse and Retractable Keyboard Remote. Coliseum Screen 2 we call the “Universal Gem Screen”, rectangle shaped, push button for digital full screen, or multiple screen variations and maneuvers all at the touch of a button. This screen shows a lot of class it has every feature that screen 1 has and more. Screen 3 universal screen is a 4 way box style screen with screen on every side and very flat screens, ¼ inch thick. Similar to Coliseum Screens 1 and 2 offers so much more to do with these multiple screens. By this machine being keyboard/remote driven you will be able to add a second keyboard, second or third remote for other screens or use your cellphone for actually controlling entire system through wireless and sensor signaling communications or computing as well as handling the machine through sensor driven devices. Multiple sensor driven keyboards as well as multiple sensor driven remotes, will bring this Transfortainment Phirst Classic to life.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a front view of an ear all hearing device, remotomouse, retractable functional keypad and the subject shadowing function;

FIG. 2 is a top view of the dust shield wiper, tell tell indicator, digital projection grid, all digital camera probes 5 in 1, the buzzy bye system;

FIG. 3 is a front view of a digi-sensor, grav-draulics pod, satellite lauch pad keyboard, coliseum screens, indigimation phone system, stay flossy, eye level technology, digitainment cam, night watchman, galaxy viewing, major link voicecom system, access mobility pilot, emergency dispatch assistance, ttm (transfortainment teller machine), system scope;

FIG. 4 is a front view of a my flavorite pen t.w.i.n.coustic speakers/air freshener/air purification/air conditioner;

FIG. 5 is a rear view of a multi way transformation card system, swipe card system, arsenal tower, system insulated firewall, digital style voltage transmitter, multi global style formatting excursion, digital solar chipset, explosive sorter drive, all digital illuminated usb portability style interface, z:/ co-pilot, multiple rom-mobility, the mini spectrum port holes function, virtual aqua display;

FIG. 6 is a perspective view of a deputy series storage unit;

FIG. 7 is a top perspective view of a retractable keyboard remote; and

FIG. 8 is a perspective view of an index scan.

For purposes of clarity and brevity, like elements and components will bear the same designations and numbering throughout the Figures.

### DESCRIPTION OF THE PREFERRED EMBODIMENT

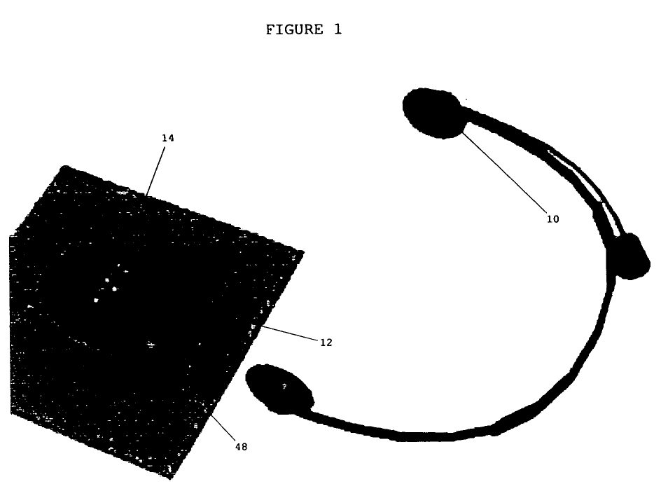

FIG. 1 is a front view of an instrument called the Ear All Hearing Device 10, Remotomouse 12, Retractable Functional Keypad 14 and the Subject Shadowing Function 48.

Ear All Hearing Device 10 aka “Ears to you” living through modern technology, now you will be able to test hearing through modern day programs that will allow individuals to test their hearing in the most absolute safe conditions. This modern technology will not require any kind of objects to be inserted into ear. Using ½ inch transistors, cross over signaling, infrared signaling, miniature probes for accurate results. The Ear All Hearing Device 10 is bowed and rounded material, 9 inches in flexible polyeurothane style. Left/right ear pieces made of ⅛ microdot style hearing device. Black felt coverings for each ear piece. The earpiece consists of ⅛ thin fiber optic coil tweeders, woofers, and driver style effects all in ⅛ mini-micro frequency plate. 7 inch plastic tubing with fiber optic lines and sensors for mouthpiece bridge. Versatile and interchangeable/detachable ear pieces and styles for comfort. Such as ¼ inch in diameter, metric ear lobe cushions and protectors from moisture as well as 1 mm microbes, acoustic tube layering for maximized levels of bass treble and frequency resolutions and aptitude. Flavor colors to taste for desire. Other useful choices are, when using the Ear All Hearing Device 10 it will consist of 9 Inches in flexible duroplastic. Tiny conductor style wiring along with transmitter style transistor components. Special Ear All Hearing Device 10 Note: Ear piece materials, circuitry, wiring and fiber optic components as well as duroplastic and plastic tubing, moldings can be added or subtracted as desired.

Remotomouse 12 versatility's includes mouse portability (wireless), enables individuals to use Remotomouse 12 and many optional situations for a variety of multi-tasking such as ¼ inch with split second reactors and state of the art circuitry time shifting, fiber optic wiring, ½ inch sensors for system indicator detection, silicon chips, ⅓-inch microsensor style resonators and connectors, ½ inch connected to motherboard. Other useful choices when designing the Remotomouse 12 are 4½ inches in length by 4½ width. Multiple desired colors. Made out of a duroplastic coating. Ergonomically correct. Less than 2 fl. Oz in weight. Thumb and index sliding lid, rubber thumb grips, ambidextrous settings. Components inside the Remotomouse 12 are digital medium transistors or less in board circuitry. Remote sensored. Dual serial port connected. Illuminated bottom interface as well as mid section. Infrared style light signals. Battery/solar/transmitter all suggested if desired. Printed circuit boards. Battery life (optional) contacts/receptors/resistors and transmitters. Integrated circuit chips. High/medium transmitters/resistors or more. A multi 20 pin dual style inline linkage or more. Multiple color leads. 1 black transistor lead. 1 all clear resistor lead. Resistor line yellow. Two Resistors for screen capacitor (Blue), green resistor and compacitator (Tan Disk). Receiver and demodulators (dual for speed and reaction if suggested). Circuit boards, fiber glass, chip transistors are made out of thin copper wire. Buttons made out of thin rubber. Black conductive disk, equipped with infrared style LED or Light emitting interface. Internal spy-light consists of usage of an old/new school components using many tiny receptors. This is how our digital light format interface is made possible with the usage of fuse light style bulbs. Transistors will amplify the signal. Signal demodulator for reading codes and Remotomouse 12 extensive storage capabilities. These demodulators allows system to examine input/output and transcribe codes, transcript errors, line level capacity. Line levels allows data to be sent and received through Remotomouse 12. Board consists of registers and gates to send data to the system. Alarm's—“Start” and “Stop” function bits (to do a variety of tasks by adding or eliminating bits to your desire). System and integrated bauds interfacing allows on time/off time carriers. Streamlines of numbers, rising or falling edges in data stream. Data stream of numbers may equal rising or falling edges in data streams. Whether it's converter value, binary programming, similar to modern day software programming, will keep track of all commands in the Remotomouse 12 utility file. The intercom system is internal along with 3-speed vibration massager for tired hands, and carpal tunnel. the intercom will allow consumers systematically to talk in a variety of ranges as well as transmitter actions. Intercom will allow you to voice over all home audio and in range audio systems, such as car, home electronics, phone systems/cell for emergencies etc. Intercom system is interfaced with pin like fibers, fiber optic resistors, condensed speaker applications. Massager is made up of miniature fiber optic lines and condensers forming a miraculous stream of continuous pulsation. Special Remotomouse 12 Note: Because of the variety of capability functions and series options of this machine or machines, circuitry boards, and all wiring can be added or subtracted to desired needs for application.

Retractable Functional Keypad 14 consists of the use of this remote control style wireless/cordless keyboard to control the entire system away from the system itself as if it was a game controller. The Retractable Functional Keypad 14 controls the following: Emergency red key, picture screen-to 32 picture screen, playback in picture, multiple screen set-ups, turn on back, push up for screen or screens, screen saver, multi Levels. Video cam, karoke/Voice Mic, dust shield wipers, extension handles for screens, and snapshot pictures, multi Levels. Hydro-lift screen adjuster multi Levels. Side to Side, front and back, system illuminates, LCD/LED style functions, time, weather, temperature, pager, instant message, scores etc. Multi Levels. Televisual translations, multi levels of pixel in pixel as well as picture pixels interface, mini port holes, game functions multi Levels, CD and communication levels, system tell tell and system check multi Levels. Using our Access Mobility Pilot 68, interface, completely digital and wireless by sensor, headphone piece, microscope, magnify/cam, built in intercom, built in back up generator multi Levels. Built in cleaning system, floppy disc system, double CD, multiple transformation functions, AM/FM cassette, pull out functions, mini cassette, mini disc, laser disc multi Levels. Beta ports, voice activated planner, VHS ports, computer mileage meter (detection of any system problems.) picture-fax-printer functions, ADA joystick, Angle-lator see movies, television, video etc. from every angle and dimension. Surveillance cams, save commercials, funny bloopers, reruns, movie pictures, save, erase by hand or touch screen multi Levels. Movie/game/cellphone/camera phone, upload/download, transfer for a real motion pixel experience. Through transfortainment television all of the yesterday remedies to the modern world at that time will be digitally converted through a massive global metamophorsus to our present state and all futuristic campaigns. (Film edit-splice-transfer search, voice, or no voice-blend music) (screen translations in picture). turn on clean air filters, touch screen note pen (My Flavorite Pen 26 that writes messages through laser transmission in mid air without ever touching the screen or pad), mixing capabilities, keyboard writer, shows illustration of the entire system, also has on screen help strategies features, multi levels. Access Mobility Pilot 68 disability functions; sign language reader, braille, hearing device and joystick capabilities multi levels. Extra features and upgrades, improvements, and modifications, multi levels. Key mobility function for communicating with other devices as well as our Digi-Tasking-Mobile Cycle Devices for Maximum Mobility. Personal Banking Functions, electronic photo as well as fingerprint scan/identifier on keyboard, remote, voice activated and touch screens. Grav-Draulics 24 screen pod. Digital electronic swiping system/swipe transformation card for data and very quick downloads on multi levels. Personal design and color flavors of systems for desired taste. Transfortainment Internal/External Mic Control 86 voice activation enables system to automatically adapt to voice instantly. To control entire system even from a whisper. Changing channels, pausing system, mixing multi-screens, turning system on/off etc. Core streaming of ¼ inch transmitters. Extreme high levels of terabytes for memory challenge. ¼ inch laser components for voice pattern, range and width connected to motherboard. Special Retractable Functional Keypad 14 Note: All keypad functions will rely on ½ inch resonators, 1 or 2 mm transistors, ¾ inch conductor chips for massive transforming and component development. 2 mm fiber optical reactors, add or subtract for more speed, all components and wireless interfaces will reside in coolent substances or coating and housed in a orderly component community on the motherboard for non interference and will be in a smooth and fanless state of operation.

Subject Shadowing Function 48: Enabling individuals to place live subject features on hold as you would your today landlines etc. and monitor their feature/images at the same time, while on other line or party lines, never forgetting whose image is on hold, along with the time, how long they've been on hold and you can actually record, playback, upload or download these subject features/images for personal library, using the “Subject Shadowing Function 48” system along with present and futuristic phone capabilities. ½ millimeter micro component on condensed fiber sheet, that can be integrated with media server engines. Also digital content drivers, along with working multiple devices all at the same time on motherboard. Using multi digital transfortainment linkage, alternatives will allow constant communication throughout the globe, able to talk to multiple parties, put parties on hold, automatic language translation receiver, built in coding system and analog. One number or one letter can mean a whole sentence depending on charts, creativity, and integrated programming, depending on programming etc. 300 mm optical multi-core, coinciding with 2-inch digital adapters allowing versatility in sharing and transmitting communication files, all on motherboard.

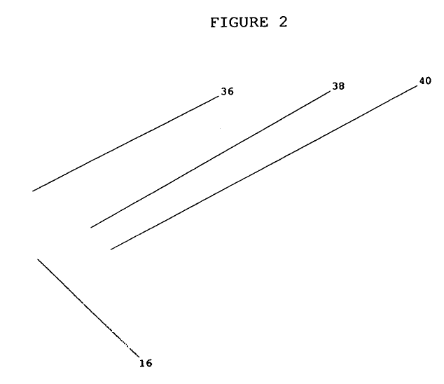

FIG. 2 is a top view of the Dust Shield Wiper 16., Tell Tell Indicator 36., All Digital Camera Probes 5 in 1 38., Digital Projection Grid 40 and The Buzzy Bye System 66,

Dust Shield Wiper 16 w/screen spray solution/enabling individuals to clean screens from the smallest of multi-tasking mobile-cycled devices to 15 foot or more size screens. 3 or more speeds all at the touch of a button on your remote or sound of your voice, manually as well as spray dry solutions for screen cleaning. ½ inch insulated duroplastic base surrounded by two small fiber optic connectors/air compressor/valve component, 1 mm in dimension, thermo insulated, multi way spray devices with constant motion, all on motherboard. This device consists of detachable unit face. It can be installed on top or bottom of Coliseum Screens 22. Inside base of the Dust Shield Wiper 16 consists of ¼ inch engine driven cylinder with (1) ½ inch reactor. Entire system will be less than an ounce in weight with 4 holes on each side. At the very tip of wiper there is a spray/mist cylinder for screen Dust Shield Wiper 16 solution. Unit dimensions are approximately 3 to 12 inches in length or more, ¼ inch in width easily adjustable retraction, made out of rubber and duroplastic coatings, for flexibility, multiple colors to choose from. Special Dust Shield Wiper 16 Note: Because this is a series, all wiring and wireless devices can be added and subtracted for baud speed and more sophisticated applications as desired or when needed.

Tell Tell Indicator 36 is flashing green, yellow or red lamps that is used for distinctively operating the system smoothly. The Tell Tell Indicator 36 lamps are either green if the system is running fine, yellow if there's caution and red is an extreme warning if there is a malfunction of some sort about to happen such as a hard drive crash etc. Tell Tell Indicator 36 is designed with ½ mm style coils, readings, digital ray sensors to coincide with entire system. ½ mm vinyl coating style window to see lamp or flashing light. The Tell Tell Indicator 36 lamp is fanless, solar driven and virus free.

All Digital Camera Probes 5 in 1 38 is located at the top center of Coliseum Screens 22 (television/monitor) and is linked to components internally through Arsenal Tower 34. These probes will allow the user(s) to orchestrate probe settings using any multiple direction. The user will have constant awareness through these probe surveillance cams by use of digital, satellite and GPS sensors. The All Digital Camera Probes 5 in 1 38 will be 2 or more thin micro millimeter style adjustable stems. Illuminations and colors are optional for the All Digital Camera Probes 5 in 1 38. ½ inch oval units, mini transistors located in circle gap for visual as well as sound and motion. (Heat is optional).

Digital Projection Grid 40/this overhead style projection has many features for the office or on the go mobility, allowing information to be faxed, voice text messaging, satellite linked, along with phone presentations will be just a few of the variety of new ways to process information from in or out of the country or extended distances right to your digital projection cam for presentation of any sort. ½ inch mm memory and LCD style chipsets for virtual reality and wide angle viewing, 3 demodulator chips and micro mirror chip devices. Light valves ¼ inch×¼ inch for dimension purposes, ½ inch mirror devices, include liquid style crystals and centimeters thick all on same motherboard.

The Buzzy Bye System 66: Enables clock to alarm through voice preference for wake up calls, visual imaging of yourself, favorite videos or something horrible in taste for that immediate wake up response. The Buzzy Bye System 66 gives weather reports, current news updates, phone calls, text messages, calls in system that may have been put on silent mode or hold screen through the course of evening, weekend or vacation. Allows the system screen to illuminate entirely as one of many silent modes, also buzz as vibration mode, performs applications through satellite for constant change and reactions etc. Components consists of ½ inch micro wiring, silicon sensors. Quadruple core processor, ½ inch reactor chips, thermo insulated, all on motherboard.

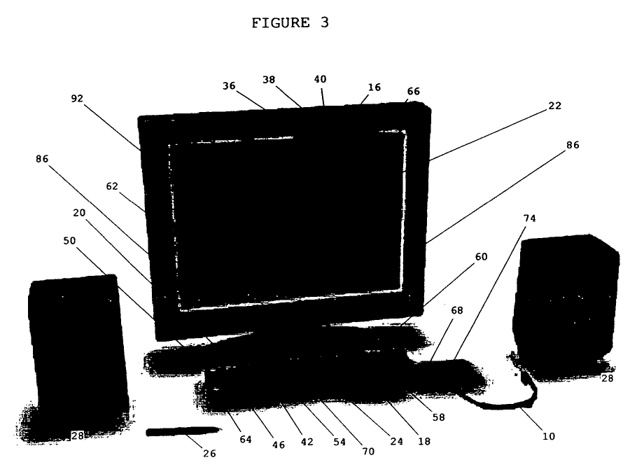

FIG. 3 is a front view of the Digi-Sensor 18 (Digital-Response, Meter/Signaling Device), Grav-Draulics 24 Satellite Launch Pad Keyboard 20, Coliseum Screens 22, Indigimation Phone System 42. Digitainment Cam 50, Stay Flossy 46, Night Watchman Visual Surveillance 58, Galaxy Viewing 60, Major Link Voicecom System 62, System Scope 64, Access Mobility Pilot 68, Emergency Dispatch Assistance 70, TTM (Transfortainment Teller Machine) 74, Eye Level TechnologyThe Digi-Sensor 18 allows users to have complete digital control of system through multiple wireless attributes and sensor versatility. The Digi-Sensor 18 device can be controlled and operated using a simple touch or voice command through graphic signaling along with resonator style transmitter linkage. User(s) will be able to create, redesign and multi interface with today's as well as futuristic technology in the simplest integration of its form. Using (1) ½ inch×½ inch circular disk. Made of fiber optic plastic insert. Fiber Optic lines, ½ inch casings, 350 mm fiber optic circuitry with baud speed response. Hairpin modulators/transmitters and needle size reactors for all motion. Housed in its own compartment at bottom of screens. Flashing light indicators, designed of ¼ inch of micros, microprobes unit, and transmitters to coincide with system indicators at all times. Multi-infrared style coloration/sensor signaling colors to taste and desire. Digi-Sensor 18 also enables communication through infrared signaling and motion applicators throughout system and accessories. (2) ¼ inch 64 bit server style chips for overtime operations, satellite style connections such as circuitry, scanning, high viscosity, and multi-warp speed results frequency chipset connected to motherboard.

Grav-Draulics 24 (a hydraulic base stand with multi directional motions and functions), enables Coliseum Screens 22 or multi-screens to fit very nicely on this remote controlled Grav-draulic pod. The base can sit at floor level and extend over 10 feet tall or to preference with virtual gravitational components, allowing the system pod to sway back and forth, side to side, turn 360 degrees also with many other flexible capabilities. ½ inch crane style micro-engine that generates several micro horse powers in waves to all parts of the body of the motherboard for precision type functioning for the Grav-Draulic stand. (2)—½ inch gear pumps, pressure/outrigger that holds mini components for over working this incredible stand. All on silicon chip on motherboard. The Grav-Draulics 24 introduces an extreme motion at its finest by using 1 inch to 10 feet tall in rod style linkage for stand height. Through remote operations and multi lines of conversion formatting, device sways back and forth, up and down. It has one small compacitor. (2) mini microbes, each ¼ inch in diameter. Capable of setting multiple flat screen panels on pod at once. Di-casted plastic/duroplastic coating. Many colors, shapes, and sizes (example): Strawberry Cheesecake, Banana, Peaches, and Cream etc. Base of stand 3-inch oval disk, length 5 inches wide made of duroplastic coating, controlled by ⅓-inch engine driven module for motor. Fiber optic wiring, needle style coils, ½ inch coil springs, ½ inch hydraulic tanks, also ¼ inch motion spring, all controlled by sensor gratification. Flavor colors/gloss to desire as well as overview of entire system coloration. Special Grav-Draulics 24 Note: Grav--Draulics Pod materials, circuitry pumps, moldings, engine driven components and all motor circuitry can be added or subtracted as desired.

Satellite Launch Pad Keyboard 20 enables emergency communication style response, along with all of these great key functions, for many system transactions at a touch of a button, voice activation or a simple touch of a screen depending on mode from satellite keys. (3) ½ inch silicon units responding to resonators and two connectors coinciding with a 12 inch strip sensor, for automatic sensor response to keyboard stringing, massive forms of coding over digital media. Adapter or system drivers will be on a 1 mm virtual chip (wireless analoging) reaction time will be perfect for multi-networking and mainframe purposes all on motherboard. The Satellite Launch Pad Keyboard 20 shows entire system illuminates automatically when extra light. This unit consists of basic rubber base settings and general layout. 124-key keyboard, typing keys, numeric keypad, satellite keys, function keys—S-1 through S-15 control keys, Index Scan 52 adjustable container, communication linkage, keypad consists of pound sign/star sign, small flashing green key for answer, small flashing red key for hang-up, volume and illumination/lighting. There are many sequences in this basic key lay out, spill/foreign object proof layer covering and resistance to corrosion. 4-pin USB connectors using about 5 volts to function. Using the IC (integrated circuitry) rubber base switch keyboard, for great tactical response, key matrix carbon center. Inside the Satellite Launch Pad Keyboard 20, key matrix style formatting, bounce typematics, microprocessor and circuitry board. For Example: the key matrix style formatting will form a grid of circuits underneath the keys, broken below a specific key when keys are pressed, it will bridge the gap in circuitry of course allowing tiny molecules of currents to flow through. The processor monitors all key matrix style formatting for signs of continuity at any point of the grid. When it finds a circuit current, that is closed off, it will compare exact location of that particular circuit on the key matrix style formatting to the character map in the read only memory. The character map equals basic comparison charts for the processor that tells key coordinates in the key matrix style formatting. Processor checks destination of character map. Character delay will range from 30 character per second (CPS) to as few as two (CPS) or less. Keyboard made out of sturdy duroplastic. Illumination (Optional). Performed by mini fiber optic lines and nano connectors. 12×4 inches in dimensions using our “Transfortainment Mobilosity”. This is a breeze for typing, using the digital activity center, style televisual unit with communication linkage, or any transactions while in transit or motion. Special Satellite Launch Pad Keyboard 20 Note: Because of the series, material/technology can be added or subtracted due to desired preference or performance.

Eye Level Technology 54 is a multi combination of everything from screen testing for vision for glaucoma, pink eye, sensitive eyes, cataracts, you name it. It can be discovered in this new high tech wave of what we would like to call “All Digital Visionology”. Multiple ½ inch probes along with multiple ¼ inch transistors and receptors for accurate readings from basic charts to professional type high tech optical vision testing. Through modern day research our goal is to be able to get results before appointments with ophthalmologists. This will enable clients to be able to send electronically, globally, fax or print out results before hand and that would speed up crowded offices.

The Coliseum Screens 22 are television panels, reversible/detachable screens, multiple in color. digital camera probes/projectors, Internal/External Mic Control 86, plasma style, flat (as in millimeter thick) panel, reversible screens. (Other fine options) Coliseum Screens 22/Monitors and ports all wireless sensored, enables spontaneous infrared signaling to be a breeze and become the normal way of life on this one. Using 2 piece nano wiring, ⅓ inch fiber optic chipsets, super-mode reduction intersecting ultra low power, systematic, all on one chip. ½ inch in diameter, wireless mobility, vectors, file formatting and transcoding ability will be quicker and easier on each vision ray. There will be triple ray beams for red, blue, green and black, Multiple unlimited pixel density DVI level style high resonation formatting. Enabling individuals to experience a fortitude of denominators that was once impossible to bring together. It has clarity at its peak along with a mirage of circuitry input that's very compact, very smooth etc. Small group of fiber optic cables, fiber optic cards, that corresponds with VGA and DVI output style sensor ports. Many miniature microbes versus silicon chip. Converting together to make everything from television to the way you view computer operations, very futuristic. It will be on a whole different level. Through this precise method will give excellent analog to analog more versatility and cable setups who can triple link and quadruple link format connectors. 80 hertz of LCD style techniques in display can resolute 1930×1090 easy, while DVI can link resolution of 2050×1540 or better easily formatted. Representing each motion pixel community. All Internal LED/LCD style processing: enables all access for reports, reminders, notes, all forms of messaging, multi size captions and multi language translations with multi screen advantage etc. In connection with fiber wiring, ½ inch sensor reactors. Modern capabilities through wireless experimenting, goals are smaller and faster chips will enhance high tech interfacing through these high tech resolution chips, terabytes, stronger configuration communities, high frequency memory channels, larger bandwidth and supersonic transistors all on motherboard. Equals 3 election style interface that move simultaneously across screens. Eternal formatting of components generates red, green and blue style rays. The entire Coliseum Screens 22 will be ran with infrared fiber optic style rays and massive thin nano-precision resonators and connectors. The Coliseum Screens 22 are very compact with one storage area in the back. Coliseum Screens 22 will have one unit to deal with in case of malfunction or maintenance preparation. Multi Coliseum Screens 22 will be palm size to one hundred inches. Front and back monitors will be a quarter inch thick, back to back with a connect and disconnect divider clip. Coliseum Screens 22 are coated with red green and blue style rays, arranged in multiple dot style vivid formations and stripes. Coliseum Screens 22 will contain a perforated shadow mask with pin size holes aligned with the rays, more dot formations, or stripes. All digital on Coliseum Screens 22. Red dot formations will be fired from a red beam at red style rays with similar production for green and blue dot formations. Creating multi white dot formations, red, green and blue style rays will be fired simultaneously. The same 3 colors mixed together to create white will also create a black dot style formation pattern. All rays will be turned off as they scan pass the dot formation. All other colors on the Coliseum Screens 22 will be combinations of red green and blue style rays. The Coliseum Screens 22 of course contains an aspect ratio and viewable area; two measures will describe the size of digital Coliseum Screens 22 displays. An aspect ratio of 4:3 or more, ratio of width of display screen to height, will give an approximate count of 4 to 3. Coliseum Screens 22 will have a LCD style format Monitor, 16:10, or 15:9 wide screen. LCD style displays a combination of very useful viewing. DVD's, movies, 3-D operations, animations and matrix in wide screen formatting all on satellite by demand. Game multiple windows side by side, for example: (This Altitudinous Televisual) will also use a wide screen aspect ratio. This will be all new “Transfortainment”. Projection surface (screen) screen size LCD style indicators will be measured diagonally from inside of the beveled edge. Does not include casing. Main concepts and applications on how the Coliseum Screens 22 will work along with all of the above will be as follows: Phosphorous/high resolution blue style rays. Shadow mask glass/thermo interior substance digital/satellite style signaling. Coliseum Screens 22 has single fixed resolution and refresh rate. Graphic adapters for exact signaling, multiple scan monitors, monitors that will understand any level or frequency within a certain bandwidth, change resolutions and rates without having to install any new graphic adapters. Attributes, evaluations, high tech tube, horizontal and tiny vertical wiring, flat face plate, round perforations, fiber optic transmissions, sharpness and multi images measured by micrometers. Diagonal between two colored rays is how we come up with our dot style formations pitch. Horizontal to simultaneously flashing colored rays. Horizontal will be measured from the distance between two like colored rays horizontally. Horizontal distance between two light rays will create the many stripe style pitch formations. The Coliseum Screens 22 perforated style dots and pitches will translate/interpret directly into the resolution of the Coliseum Screens 22. The number of dots per square, micrometers and per square inch will represent each of the common dot style pitches. Refresh rate will be the number of times image displays will be drawn up. Each milli-second/each second. 80 hertz or more will cycle through every last multiple pixel in pixel style layouts from top to bottom, 80 times a millisecond/second or more. They will master the flicker two cycles or less per second, all digitally synchronized. Special Coliseum Screens 22 Note: Because this is a series of machines and because of the variety of capability functions and series options of this machine or machines, circuitry boards and all wiring can be added or substracted to desired needs for applications.

Indigimation Phone System 42 enables individuals to communicate internal/external as well as interface with all present and future phone system capabilities. Optic wiring half millimeter in dimension, precision crafted, network device chip, server cables optional, integrated style illumination sensors, mini ½ inch resonators, tiny fibers, transistors, ½ inch high frequency modulators/ demodulators, maximum interference chrystals. All crafted on motherboard. Multi linkage capabilities now enables individuals to communicate around the globe internally through system, satellites, and multi-media server capabilities. ⅓ inch band micro circuits, mini resonators, nano transmitters, all coinciding with 8.0 or higher in quality for surround sound components. all on motherboard. Indigimation Phone System 42 enables you to dial out and receive cellphone, cordless or home phone for home phone usage or transformation in different mixtures of streamline functioning. ¼ inch fiber optic memory devices, 1 mm silicon chip for massive communication support. Micro-processing will be a plus for streaming high frequency media drivers for large cellphone activities, all on motherboard.

Digitainment Cam 50 enables digital state of the art filming and production type formatting along with modern analoging. The Digitainment Cam 50 uses several resolution options with built in light, regulators, sensors, as well as extra midi devices and USB ports for community creativity and featured film style access while filming. 1 mm chips will broaden specifications while making digital content design easy to access especially the energy efficient chips that will be in full swing united together. Digitainment Cam 50 also allows virtual spiraling, animation, matrix networking for personal video game creations as well as graphic streaming. 1 inch fiber optic sensors, 1 mm resonators assembled blue style rays sensored chipset, 2 inch digital adapter that will allow adverse capabilities and multiple experiences such as in view files and multiple ray changes at one time that are capable of shared memory, multiple optimizing, high density and ray scanning all on motherboard. Digitainment Cam 50 enables extension for more precision in multiple avenues of camera development, such as motion, space, still shots, underwater, underground you name it. Multi 1 mm circuits as well as ½ inch microbes, super memory components, 250 mm support devices, maximum chip range with maximum capacity on 350 mm, ¼ inch drums all on mother board. Digital Camera Probes/Projectors, Internal/External Mic Control 86, plasma style, flat (as in millimeter thick)

Stay Flossy 46 is by using modern day microbes, miniature components, and dental hygienist style motherboards and resonators, that's used in already existing mechanisms for modern day systems and up to date technological research. Our goal is to create a whole new way for flossing, discovering plaque and cavities, close up viewing through ¼ inch magnetic type flossing bands or silicon style light weight duroplastic micro picks for mirror imaging, photo imaging, infrared automation and all digital application, all done over system, for your records as well as pre-appointments and future appointments and consulting an orthodonox. Using actual pictures and discoveries, you can now 'show records, opinions, results etc., all through fax, email, print outs or globally. This system is designed to be sanitary and very safe.

Night Watchman Visual Surveillance 58 enables one to never give up your position while being able to track all outdoor/indoor activities due to infrared probes and tracking sensors through satellite and GPS. You can now see subjects walking through neighborhoods, kneeling down between cars, standing in alleys, even zoom in on roof top activities you name it. It can be reported instantly to police, FBI, or any law enforcement agency. Baud style circuit board units, ½ inch by ½ inch. ½ inch silicon chips, 3 dimension wiring with use of digitize devices shared from network software. This will cause you to navigate with precision by voice, remote or structure manually connected to motherboard.

Galaxy Viewing 60 power style magnification through satellite imaging and infrared probes. You're now able to watch what's going on live on the moon, watch the stars, see rainbows, watch around the globe, watch the sun rise and set in any area of the world, anytime of day or night and even watch the snow fall in different regions of the world etc. Through a special service of course. Components contents are ½ inch mirror signal for collective light and magnified images, less than 15 centimeters in scope viewing will now give a read and write distance for over extreme distances. ½ mm component for concave, remote prevision, scan probes, system check access points and frequency routers. Multi maximum terabytes for extra strength in magnification all connected to motherboard.

Major Link Voicecom System 62 enabling you to communicate throughout the home, office, hospital etc. Depending on transistors and reactors you can communicate in extended distances over system or maximum mobility devices. ¼ inch fiber optic circuitry, 4 pin microphone connector, ultra light intercom boxes, 2 micro-conductors with super audio signal circuits, semi micro AC couplings, 1 inch all sides. Sending to 30 to 35 volts filtered in DC supply all on micrometer silicon components on motherboard.

System Scope 64 features scientist vision magnifying and extensive science research applications which enables you to test or dissect lab experiments hands on as well as virtually with the family or the kid's project in the safest fashion through accessory kit for system. Extreme multi-tasking testing kits for live cell testing and results that will appear on screen for class records, homework etc. Components are ½ mm on thin fiber optic sheet, ¼ inch chip, silicon chip for solid sharp focus that will control vertical distance depth of field, range, field of view, focus point, focus length, magnification, numerical aperture, resolution, lamp and illumination all on same motherboard.

Access Mobility Pilot 68 enables system to accommodate immediate change and on the go spontaneous responsiveness to meet the needs and demands of the disabled community at all times. Components are quadra-circuitry, amazing dynamics in feeling, sight and hearing. State of the art transmitters, transistors and reactors for split second responsiveness connected to motherboard.

Emergency Dispatch Assistance 70: enabling emergency response to be seen and heard by other agencies or mobile units that may be very close in the area for an even quicker response etc. For instant response whether system is activated or not through transistors, tiny molecules, ¼ inch modulators and GPS or simple voice activation, all wiring connected to motherboard.

TTM (Transfortainment Teller Machine) 74 enables all levels of banking transactions made possible and in the most safe manner also enables gift card style creativity for individuals to design cash cards from home also to download/upload funds to and from banking institutions globally and always very safely, along with many other capabilities. 5 USB style communicating modules, fiber optic microbes for always correct on time communication. Major 350 mm microchips that's versatile in durability and lengthy in operation, two fiber optic lines connected for illumination and for superb readings and color content basic or cable versatility, device indicators, display transmitters all on super ultra wide-band, high bandwidth will be made possible through existing electrical wiring and interface networking connected to motherboard.

Internal/External Mic Control 86 is located at lower middle side panel of Coliseum Screens 22. Features are 3 snake type perforations, each ½ mm in gap. Mini fiber optic insulation coils on both sides of screens. ½ inch transmitters, resonators. Mini illuminating fiber optic wiring for mic support.

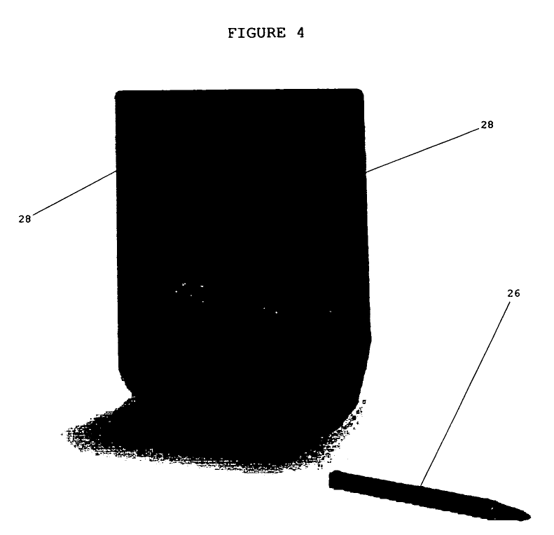

FIG. 4 is a front view of a My Flavorite Pen 26 (a multi digital-tasking writing utility/ray beam usage device) and the T.W.I.N. Coustic Speakers/Air Freshener/Air Purification/Air Conditioner 28.

My Flavorite Pen 26: Consisting of 6 Inches in length, duroplastic coating, insulated 1-mm magnetic fiber optic internal strip, ¼ inch in width with clear upper window. Multi color levels, color changer. Made out of magnetic food color graphics. Rubber grip at lower bottom of pen. Runs on 1 mm fiber optic circuit, coil and nano illumination fibers. Flavor/Gloss coloration to desired taste. Special My Flavorite Pen 26 Note: My Flavorite Pen 26 materials such as circuitry fiber optic, color banks, plastic moldings, nano circuitry are all based on desired measurements and focus.

T.W.I.N. Coustic Speakers/Air Freshener/Air Purification/Air Conditioner 28: consists of a set of two, two-sided speakers. Each speaker has 7½ inches in length, 3½ inch in width, ¼ inch back to back in thickness. Speakers will be squared or any shape, size or color upon desired taste. Produces audio signal/sound reproduction, frequency, electrostatic, woofer, low frequency range, planner style in magnetic speakers, consists of long medal ribbon, suspended between two magnetic panels, alternating positive and a negative current with a movement of the diaphragm style activity. Magnetic field can be optional, rather than electric field, with extraordinary precision, sounds are defined. The planar magnetic speaker will be used as a tweeder along with traditional dynamic drivers. Our T.W.I.N. speakers will be used in conjunction with driver units. Electro-air-static style speaker, speakers intertwining to vibrate air with a large thin conductive diaphragm panel. This diaphragm panel can be suspended between two stationary conductive panels that are charged with electrical current from the wall outlet or through air compressor system. T.W.I.N. speaker panels combined to create an electrical field with a positive and negative end. The audio signals will run a current through the suspended panels rapidly, switching spontaneously between a positive charge and a negative charge. Of course when a charge is positive, the panel is drawn toward the negative end of the field, also this entails when the charges is negative it moves towards the positive end of the field. In prototyping a model of the T.W.I.N., electrical audio air compressed signals can be charged with a positive and a negative current based on many multiple variations. When the diaphragm is positively charged it will normally fluctuate toward the front, depending on sealed speakers enclosures. Our T.W.I.N. Coustic Speakers/Air Freshener/Air Purification/Air Conditioner 28. systems will consist of drivers and crossovers that will be housed in a strong duroplastic speaker enclosure. Our enclosures will serve a number of functions. On a basic level everything in one-unit drivers kept to the right position. Tweeder, woofer and drivers will all work together to produce top sound. Enclosures along with enclosure plates will be built with heavy duroplastic coating also insulated to absorb driver vibrations. One of our main focuses will be how the vibrating diaphragm emits sound waves in front of the cone, while the diaphragm is constantly moving back and forth. Our goal is to produce crisp and clear sound each and every time when activated. The T.W.I.N. will produce sound waves behind the cones back and forward, top, and bottom waves as well. Enclosed are duroplastic containers that will hold a tweeder, woofer and a mid-range driver or dual drivers acoustic suspension enclosures to completely lock in air where no air escapes. Many forward waves of sound will travel outward into the room backward, sideways; bottom and top. Sound waves will travel throughout box enclosure spontaneously. (3 Speed All in one Air Purification/Air Freshener/Air Conditioner) Our air conditioner/purifier/freshener consists of compressor that compresses cool air. The T.W.I.N. is made up of freon style energy, causing solutions to become hot. Also high pressure freon energy style solutions will coincide. This hot gas will run through a set of coils so it can dissipate its heat and it condenses into a liquid. The freon style liquid runs through and expansion valve, and in the process it evaporates to be come cool or cold. This cold gas runs through a set of coils that allows the gas to absorb heat and cool down the air inside the speaker box it's mixed in with. Freon style chemicals are mixed with a small amount of lightweight oil and this oil lubricates the compressor. In our air purification system internal air pressure is constantly changing. When drivers move inward, pressure is increased and when drivers move outward, pressure is decreased. Both movements air conditioning and air purification will create a pressure difference between the air inside the box and air outside the box. We want air to move to equalize pressure levels among drivers constantly so it would be pushed toward its resting state. The position at which internal and external air pressure are the same, depends on the way you're enclosed speakers set up will be arranged. Compressed air in the enclosure when it moves in and rarefies air when it moves out. Our high level amplifier will boost electrical signals to overcome the force of air pressure and the force will serve as a valuable function, it will act like a spring to keep the driver in the right position. Air purification and air conditioning assumptions on barometric numbers, internal air conditioning humidity, and pressure will be key factors. Top relative 3 speed cooling from speakers, humidity of the air and the barometric pressures. For example: Assuming a 95 F (35 C) Day. Barometric pressure of 29.92 inches (C Level Normal Pressure) and 80% humidity is the temperature of the water for cooling the speakers will not need inside fan (fanless) (all digital driver mechanisms). Allowing temperature to drop about 6 degrees to 89 F (3.36 degrees to 31.7). Humidity is 50%, the entire water temperature will drop perhaps 15 degrees to 80 F (8.4 degrees to 26.7 C). Examples continue: Air contrast and chill water called psychometers, air conditioning equipment is centrally routed. Special T.W.I.N. Coustic Speakers/Air Freshener/Air Purification/Air Conditioner 28 Note: Speakers as well as air conditioner, air purification, air freshener, schematics can be used as desired when building. Because this is a series, systematical parts can be added or subtracted as desired. All optional.

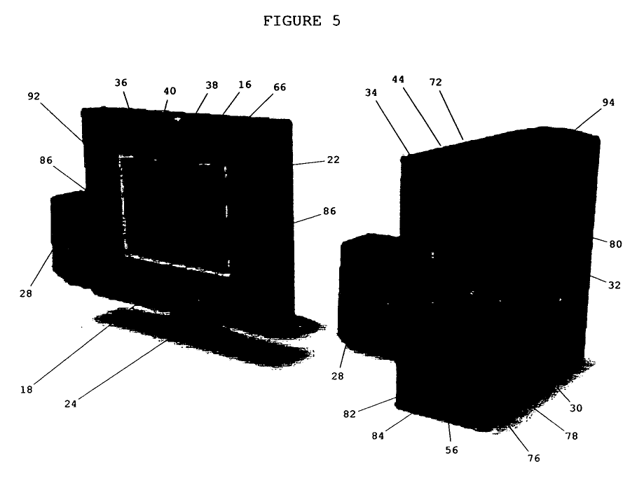

FIG. 5 is a rear view of a Multi Way Transformation Card System 30 , Swipe Card System 32, Arsenal Tower 34, System Insulated Firewall 44, Digital Style Voltage Transmitter Plug 56, Multi-Global Style Formatting Excursion 72, Digital Solar Chipset 76, Explosive Sorter Drive 78, All Digital Illuminated USB Portability Style Interface 80, Z:/Co-Pilot 82, Multiple ROM-mobility 84, The Mini Spectrum Port Holes Function 92, Virtual Aqua Display 94

Multi Way Transformation Card System 30: (a multiple way to transform all media/communication in a library form all on one card or utility device) To be conveniently produced over satellite/GPS uploading/downloading to a card or multiple cards just as if you were taping/burning/DVD converting and that goes for all midi/media intermingling along with communications. The transforming is fast digitally and accurately done. This unit consists of mini molecules and tiny fiber optic components. Multiple notches or more for read/write scanning/swiping. Magnetized stripping with non-crack surface. Transformation card can be from ¼ inch in size to credit card size. Made out of non-breakable/non crack resistant, water resistant substance or coating. Also transformation phase can be designed of ½ inch by ½-inch mini transistor plugins to unit base with days and days of planned information and formatting all on this tiny see through chipset. Colors and design will vary in taste. Very high frequency all corresponding to multi way transformation slot. ½ mm microne style chipsets, fully loaded for sharp, crisp signaling and very active, mobility and multi-tasking. Special Multi Way Transformation Card System 30 Note: Because this is a series, all wiring and wireless devices can be added and subtracted for baud speed. Allowing more sophisticated applications to be added as desired or when needed. Multi Way Transformation Card System 30 enables pull out capabilities for Digi-Tasking-Mobile Cycle Devices. Allows individuals to record business meetings, favorite broker reports, sport highlight etc. 1 mm thick reactor with state of the art micro Bauds for speed and back and fourth signaling: micro-internal engine will be great for quick on/off signaling, formatting for this fast digital device, able to evolve around high wattage, bounce between 900 MHz of frequency or higher, also equipped with thermonostic microbe wiring all connected to motherboard.

Swipe Card System 32 (create a card/module) reader. (a digital magnetized runway to swiftly create and swipe brisk information accurately and safely onto a plastic card or utility device).

Allowing equal transfer capability with a mobile on the go transfer frame of mind, such as transfortainment of music, movies, media events, sports, current affairs, seminars, financial reports, gaming etc. Multi mini microbes for precision operations. ½ inch thick, (2) 1 mm chip setting for platforms, for wireless multi networking capabilities, easy software analog with integrated high tech media preparations, in affiliation with database and top notch graphics will be orchestrated all in one. ¼ inch network driven engine, all on motherboard. Swipe Card System 32: This unit consists of ½ inch magnetic line boundaries for accurate readings every time. (2) single slot swipe information rails with gold tip laser reading applications. Made out of duroplastic coatings and synthetic fiber blend. 6 inches in length, 2 inches in width, 2 inches in center of gap. Indicator lights red, yellow, and green. Red for fault in reading, yellow is for caution of magnetization and green is for clear to proceed. 1 mm micrones, ½ inch circuitry for maximum signaling power through active mobility and on the go, multi-tasking. Colors and design will vary to taste.

Arsenal Tower 34 is a standard or flat top casing that generates every component in this system.

System Insulated Firewall 44: Digitally focused on fiber optic style insulations throughout server, tower and each unit throughout the system for safety and cooling purposes. Whether fan included or fanless to support and protect system, motherboards, circuits and components at all times. (Safety) hair pin fiber optic insulated compartment goes hand in hand with multiple ½ inch cooling mechanisms, (micro-fans optional), varying pressure, and varying temperature/able to withstand very high viscosity.

Digital Style Voltage Transmitter Plug 56 unit attach to wall unit communicating with tower components. This function enables massive design patterns for varying temperatures, varying pressures, high circuitry optimizing, built in cooling mechanisms expanded megahertz channels, ½ inch thermo coil circuitry, ¼ inch cooling mechanisms for high density operations (shaving/coffee pot/portable fan/cell phone adapters/etc.) all corresponding with motherboard. Transmitters and resistors enables system awareness, spontaneous and instant response for excessive application. −2 inch black box, thermo insulated, with many fine optic coils and receptors for wide range transmitting and community operations all at once. Now able to differentiate between frequencies, wireless/cordless, frequency chipset connected to motherboard.

Multi-Global Style Formatting Excursion 72: allowing multi chipintry/chipset in function for GPS style receivers and format sequences, satellite, almanac type storage, exact positioning and transmitting of many signals throughout conference style interface. The Multi-Global Style Formatting has spontaneous interception of multiple events such navigational and investigational services, such as bounty search for people as well as lost pets. Through digital satellite referencing in space and multi conductor analog interfaces here on earth the results will be a split millisecond reaction. All on (3) ½ inch triple core thermo insulated microchip all on motherboard.

Digital Solar Chipset 76 enables a single chip to be able to keep entire system or mobile devices running under extreme on/off activity during power outages and never lose power, information, goes hand in hand as solar back up generator system. This one will be the one to watch. (3) ¼ inch high frequency energy chips to run entire system for emergency back up purposes. Chips design 350 mm integrated for tracking and to remain as normal system interface all connected to motherboard.

Explosive Sorter Drive 78 2 or more extensive drives digitally enforced to inherit multi expandable operations under massive store and restore basis. There's no limit to these shared drives or individually structured for more personal oriented operations. A more enhanced style standard 3.5 disk increased to 3.5 disk or smaller with 10.00 MB or more in space. Connected to ⅓ inch resonator, ½ inch receptors and nano memory devices. Back up disk and start up disk all on 1 mm module accessory chips. Space for extra chip speed in use with burners, shredders, slide shows, game versatility, text messaging, faxing, scanning etc., connected to motherboard.

All Digital Illuminated USB Portability Style Interface 80 enables wireless respond to now be introduced as a first nature instead of a second nature or premature adaptation because of bad adapter responses, media responses or sensor responses. These ports are digitally designed for the most massive sensor share and wireless share of these times and the future. Quarter inch probe chip for no delay: Enabling hard drive to store music, TV style viewing, medical statistics all at one time, through a mixture of events going on all at once with no interference. AV equipped with multi level gigabytes or more per second for precision, on/off televisual-video streaming, high bandwidth speed, multi byte integrated display processor all in one. Mega 1 mm chip for serious enhance levels of tuning, audio transformation an transfortainment, all coinciding with digital CPU units 2 inches. (2) 1 mm in forms depending on form factors. Extensive Printer Port and Wireless Design/enabling individuals to have more freedom to multi-task while the world of transmissions, conductors and port synchronizing, play a major role in this one. 2 piece circuit wiring coinciding with ¼ inch insulated silicon chip all connected to motherboard.

Z:/Co-Pilot 82 enabled high capacity elevations for onsite/offsite storage of data/connected to 3-inch wireless transmitter reactors; (optional) connected to motherboard.

Multiple ROM-mobility 84: enabling instant super transformation and interfacing of drive(s) for instant access from server, tower activities, remotely streaming through sensors and infrared modulators as well as system. Quadruple multi maximum write speed with copier support to hard drive. This system is ran by ⅓ fiber optic chipsets as well as 1 inch fiber optic wiring for signaling connected to motherboard.

The Mini Spectrum Port Holes Function 92 enables individuals to apprehend unlimited pictures, videos, music, school work, communication links etc. all on Coliseum Screens 22 and make them disappear or reappear by hand or voice activation. This function allows you to move images around as if you're playing a solitaire style game. All sensor driven by Arsenal Tower 34. Component features are mini transistors, silicon wiring, cables, all on flat 1 mm cube. Silicon insulation along with ½ mm glo-wiring and circuitry units.

Virtual Aqua Display 94 enables individuals to integrate real time or virtual interfaces such as displaying a tropical fish aquarium or making it happen by virtual display of any an all desires. Through micro projection, mini transmitters, glo-wiring, probe sets, this will be even allow televisual transmissions to take place all inside the tower for extra decorative desires. For example: A display of baby animals, display of favorite flowers etc. all can be converted by a number of ways, for example downloaded from special Deputy Series Cams throughout system. Aquarium will be 12×8 smaller/larger duroplastic, fiber insulated multiple tints and virtual arrays will give multiple back drops, such as plants, barn house, extra fish etc. ½ inch insulated coils for heat and cool, non breakable, non scratchable, water resistant, 6×2 inch slide in covering for top inserts. This will never interfere with electrical operations, actually will work hand in hand and this physical as well as virtual phenomenon will be in a class by itself. This will be absolutely safe and remotely controlled by key functions. 9 inch plug in digital adapter.

Special Arsenal Tower 34 Note: (fully loaded with digital server, satellite, cable and GPS response and massive tower capability and chipsets, either flat panel or standard upright in positioning), Because this is a series, all wiring and wireless devices can be added and subtracted for baud speed, more sophisticated applications as desired or when needed, Multi Way Transformation Card System 30 and Swipe Card System 32 can be an added attraction to the rear side of the Arsenal Tower 34 for dual operations. Tower can be traditional or flat top style with maximum digital server and cable capabilities as well as Digi-Tasking Mobile Cycle device ready.

All of the following devices are digitally generated by the Arsenal Tower 34:

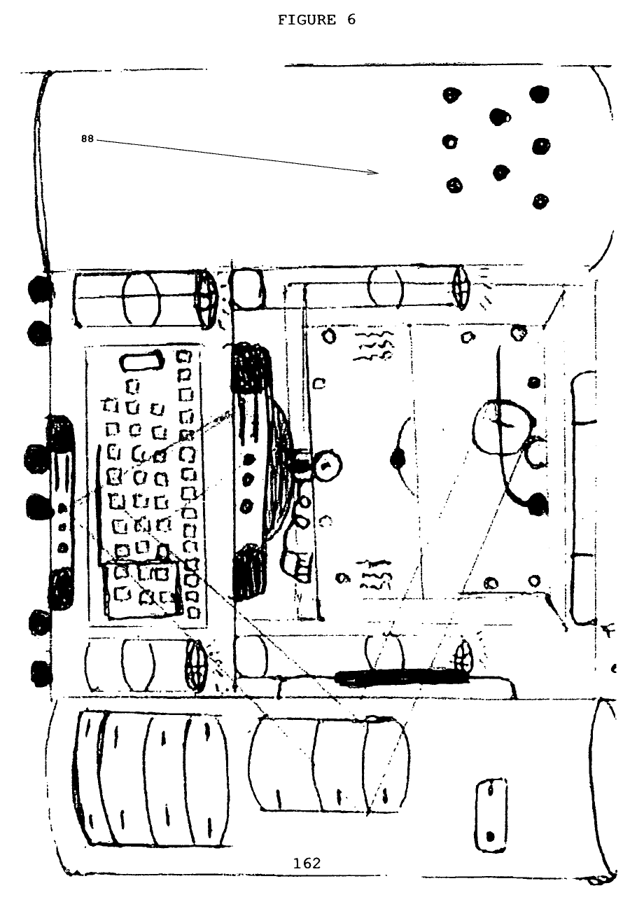

Ear All Hearing Device 10, Remotomouse 12, Retractable Functional Keypad 14, Subject Shadowing Function 48, Dust Shield Wiper 16, Tell Tell Indicator 36, All Digital Camera Probes 5 in 1 38, Digital Projection Grid 40, Digi-Sensor 18, Grav-Draulics 24, Satellite Launch Pad Keyboard 20, Index Scan 52, Eye Level Technology 54, Coliseum Screens 22, Indigimation Phone System 42, Digitainment Cam 50, Stay Flossy 46, Night Watchman Visual Surveillance 58, Galaxy Viewing 60, Major Link Voicecom System 62, Access Mobility Pilot 68, Emergency Dispatch Assistance 70, TTM (Transfortainment Teller Machine) 74, System Scope 64, My Flavorite Pen 26, T.W.I.N. Coustic Speakers/Air Freshener/Air Purification/Air Conditioner 28, Multi Way Transformation Card System 30, Swipe Card System 32, System Insulated Firewall 44, Digital Style Voltage Transmitter Plug 56, The Buzzy Bye System 66, Multi-Global Style Formatting Excursion 72, Digital Solar Chipset 76, Explosive Sorter Drive 78, All Digital Illuminated USB Portability Style Interface 80, Z:/Co-Pilot 82, Multiple ROM-mobility 84, Retractable Keyboard Remote 90, The Mini Spectrum Port Holes Function 92, Virtual Aqua Display 94 FIG. 6 is a perspective view of the Deputy Series Storage Unit 88. This unit is ultra lightweight and will be designed to house all Deputy Series units, materials such as users guides, accessories such as remotes, keyboards, speakers, multiple screens, Remotomouse 12, cartridges, and any and all media supplies. Storage unit has locking mechanism also has a maintenance storage for cleaning tools and cleaning solutions. The coverings are made of fiber glass, smooth handles for handling with wheels for motion. This storage unit is a wireless/cordless unit that illuminates at night or in dark areas. When lights go off illumination automatically comes on if desired and automatically goes off when lights come on if desired. (this setting is optional). This storage unit also is a space saver which contains flat surfaces for decorative and memorabilia items such as photos and plants etc.

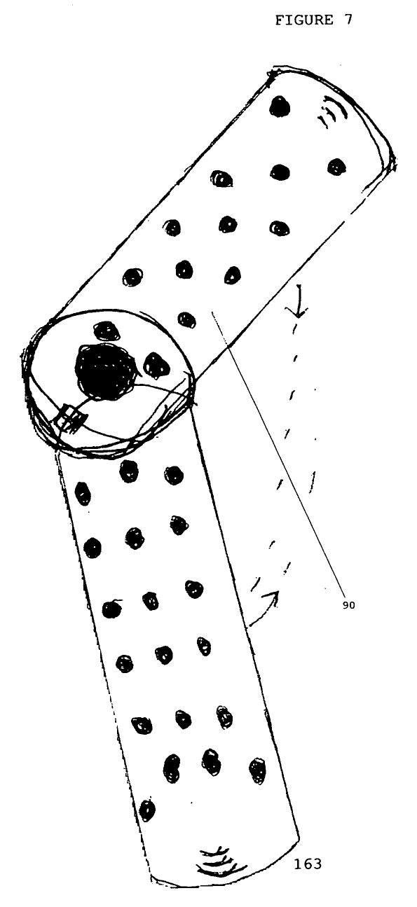

FIG. 7 is a top perspective view of the Retractable Keyboard Remote 90. This Retractable Keyboard Remote 90 has the exact same features and functions and made out of the exact same materials of our larger keyboard called the Satellite Launch Pad Keyboard 20. Designed for unlimited mobilosity. The measurements are 15×3 in dimensions and ¼ inch in thickness.

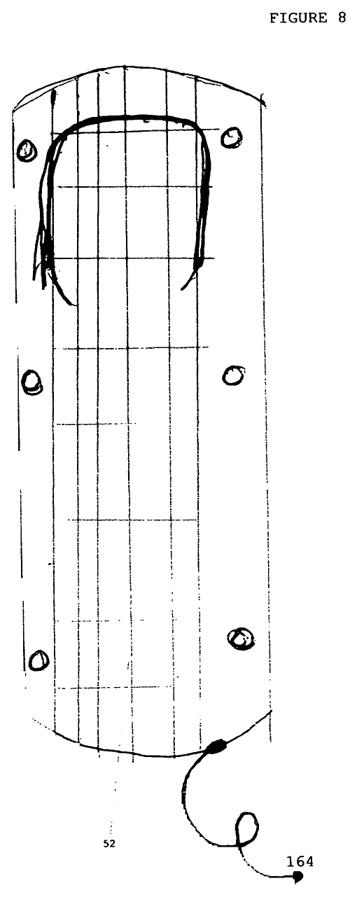

FIG. 8 is an overall view of the Index Scan 52.

Index Scan 52 enables individuals to record current vital statistics. Involves asthmatic readings, heart rate/check, respiratory readings, diabetic readings etc. Involves multiple ¼ inch image chips, silicon style pattern identifiers for ridges and valleys of pattern matches for pre-scan purposes, for correct identification of individual at all times or multi individual descriptions at one time. Fiber style converter, light emitting devices, light photons, inverted images, image definition, capacitate scanners, lightweight optic circuitry to store many charges from compacitor, maximum biometrics for accurate speed, system checks and readings, either connects onto fingertips clip on style or flat surface style scanner by placing finger(s) or thumb(s) on detection grid. This unit will pull out from the base of the Grav-draulic or pull out of keyboards via pull cord or mount detection grid on side of monitor. It can be wireless or cordless all connected to motherboard. Index Scan 52 measurements are 3½×1 in dimensions. 1 mm in thickness, powered by millimeter style microbes, ½ flat transistors, 1 mm resonators and multiple mini coils along with fiber optic firewall protection for usage with no fan, all digital in readings.

Special Integrated Software Note: Scientist, researchers and/or analyst that create new language to ensure hardware of the Deputy Series—Music Cinema et. al. will run correctly, will complete integrated software. Reminder; System can be used as a multi-multi screen as well as a massive high speed digital cable connection to attract trillions and trillions in service, for usage with or without keyboard, joystick, driving wheel and/or mouse can be Remotomouse 12 remotely driven as well as voice activated. ADA programming will allow activities to be driven depending on the impairment. Improvements using already existing products as well as new technology from today's as well as futuristic assembly lines. Systems will be available such as our Digi-Tasking-Mobile Cycle Devices for example starting with our palm held devices, the wrist top, the thigh pad system that will be great for maximum mobilosity as well as a multiple host of others.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A deputy series-music cinema or transfortainment pc (phirst classic) or digi-tasking mobile-cycle devices for maximum digital mobilosity or the digital entertaining pc or transfertainment or transformtainment or the all digital activity center or satellite entertainment mogul or satellite entainment pc (phirst classic) for retrieving globally and displaying maximum digital media/communications in all forms possible, comprising:
means for the ear all hearing device to communicate internally and externally with the whole deputy series (et.al) system;
means for the remotomouse motion on air/sensor propelled. on/off activation and deactivation of a variety of all functions throughout entire system;
means for the retractable functional keypad by using this device as both a multi digital remote tool and a wireless/cordless extra keyboard all in one feature, sealingly connected to said means for the remotomouse motion on air/sensor propelled. on/off activation and deactivation of a variety of all functions throughout entire system;
means for subject shadowing function to place live moving visual features on hold just as you would an ordinary phone call, actively connected to said means for the remotomouse motion on air/sensor propelled. on/off activation and deactivation of a variety of all functions throughout entire system;
means for the dust shield wiper to wipe clean any debris or substance away from coliseum screens with specialty cleaning interfaces;
means for tell tell indicator to activate a green flashing lamp when system is ok to use, yellow is extreme caution and red is extreme warning of system malfunctioning;
means for the all digital camera probes 5 in 1, through voice activation or use of satellite keys allowing sheer versatility in surveillance, media style projections, videos and filming etc;
means for the digital projection grid by viewing images on screen that's transferred through virtual media, animation and communication to wall viewing;
means for the buzzy bye system to wake up individuals by way of voice, video images, voice tones and this can be performed by satellite connections allowing system to change with the times;
means for the digi-sensor, an over all system signaling device that's used to read all system commands from user as well as voice activation, heat signaling response or remotely driven;
means for the grav-draulics, by producing extreme multi directional movements of the coliseum screens;
means for the satellite launch pad keyboard, by processing digital data style functions as well as one touch actions through keyboards;
means for the eye level technology to clinically test any optical conditions;
means for the coliseum screens, by watching an all digital, televisual, satellite response, navigational, surveillance, mulitmedia, communicational, informational and computeristic experiences all in one, swivelly connected to said means for the grav-draulics, by producing extreme multi directional movements of the coliseum screens, snugly connected to said means for the digi-sensor, an over all system signaling device that's used to read all system commands from user as well as voice activation, heat signaling response or remotely driven, snugly connected to said means for the digital projection grid by viewing images on screen that's transferred through virtual media, animation and communication to wall viewing, snugly connected to said means for the all digital camera probes 5 in 1, through voice activation or use of satellite keys allowing sheer versatility in surveillance, media style projections, videos and filming etc, engagingly connected to said means for tell tell indicator to activate a green flashing lamp when system is ok to use, yellow is extreme caution and red is extreme warning of system malfunctioning, and rotationally connected to said means for the dust shield wiper to wipe clean any debris or substance away from coliseum screens with specialty cleaning interfaces;
means for indigimation phone system to interact with all forms of touch screen phone communication systems and wireless landline, cell communications for extreme voice over satellite media, remotely connected to said means for the satellite launch pad keyboard, by processing digital data style functions as well as one touch actions through keyboards;
means for the digitainment cam to demonstrate all aspects of trick filming and photography, snugly connected to said means for the coliseum screens, by watching an all digital, televisual, satellite response, navigational, surveillance, mulitmedia, communicational, informational and computeristic experiences all in one;
means for stay flossy to process multi pre-appointment and pre-examination dental results for system preparation in all digital networking with dental office in a safe and in an extremely sanitized manner, remotely connected to said means for the satellite launch pad keyboard, by processing digital data style functions as well as one touch actions through keyboards;
means for the night watchman visual surveillance which is used to allow user(s) to probe very hard to see areas in nearby surroundings, roof tops, alley ways etc, remotely connected to said means for the satellite launch pad keyboard, by processing digital data style functions as well as one touch actions through keyboards;
means for the galaxy viewing feature to allow user(s) to digitally view space from virtually any place in the world on their home system, remotely connected to said means for the satellite launch pad keyboard, by processing digital data style functions as well as one touch actions through keyboards;
means for the major link voicecom system to communicate internally/externally around a variety of large or secluded areas and at extreme distances, remotely connected to said means for the satellite launch pad keyboard, by processing digital data style functions as well as one touch actions through keyboards;
means for the access mobility pilot to accommodate individuals with disabilities, remotely connected to said means for the satellite launch pad keyboard, by processing digital data style functions as well as one touch actions through keyboards;
means for the emergency dispatch assistance to communicate with any and all emergency services via transfortainment, remotely connected to said means for the satellite launch pad keyboard, by processing digital data style functions as well as one touch actions through keyboards;
means for the ttm (transfortainment teller machine) to transact all forms of banking as well as creating travel checks, cashier checks or any special banking needs legally and safely, remotely connected to said means for the satellite launch pad keyboard, by processing digital data style functions as well as one touch actions through keyboards;
means for the system scope to allow user(s) actual hands on/virtual simulation time in testing and dysecting etc, snugly connected to said means for the satellite launch pad keyboard, by processing digital data style functions as well as one touch actions through keyboards;
means for the internal/external mic control to enable user(s) to speak into the mics from left or right midway panels of coliseum screens, rigidly connected to said means for the satellite launch pad keyboard, by processing digital data style functions as well as one touch actions through keyboards;
means for my flavorite pen to be able to write in mid air without ever touching a surface using laser/ray beam interfaces with screens;
means for the t.w.i.n. coustic speakers/air freshener/air purification/air conditioner, by listening to output of all media and communications along with freshening, cleaning and conditioning the air on multiple speed by use of voice activation or remote driven;
means for the multi way transformation card system performing all digital transfers of media and communications;
means for the swipe card system to accurately read and write data to produce magnetized style necessity cards;
means for the arsenal tower to operate all digital integrated operations to be ran smoothly in the most compact form, permanently connected to said means for the t.w.i.n. coustic speakers/air freshener/air purification/air conditioner, by listening to output of all media and communications along with freshening, cleaning and conditioning the air on multiple speed by use of voice activation or remote driven, permanently connected to said means for my flavorite pen to be able to write in mid air without ever touching a surface using laser/ray beam interfaces with screens, permanently connected to said means for the internal/external mic control to enable user(s) to speak into the mics from left or right midway panels of coliseum screens, permanently connected to said means for the system scope to allow user(s) actual hands on/virtual simulation time in testing and dysecting etc, permanently connected to said means for the ttm (transfortainment teller machine) to transact all forms of banking as well as creating travel checks, cashier checks or any special banking needs legally and safely, permanently connected to said means for the emergency dispatch assistance to communicate with any and all emergency services via transfortainment, permanently connected to said means for the access mobility pilot to accommodate individuals with disabilities, permanently connected to said means for the major link voicecom system to communicate internally/externally around a variety of large or secluded areas and at extreme distances, permanently connected to said means for the galaxy viewing feature to allow user(s) to digitally view space from virtually any place in the world on their home system, permanently connected to said means for the night watchman visual surveillance which is used to allow user(s) to probe very hard to see areas in nearby surroundings, roof tops, alley ways etc, permanently connected to said means for stay flossy to process multi pre-appointment and pre-examination dental results for system preparation in all digital networking with dental office in a safe and in an extremely sanitized manner, permanently connected to said means for the digitainment cam to demonstrate all aspects of trick filming and photography, permanently connected to said means for indigimation phone system to interact with all forms of touch screen phone communication systems and wireless landline, cell communications for extreme voice over satellite media, permanently connected to said means for the coliseum screens, by watching an all digital, televisual, satellite response, navigational, surveillance, mulitmedia, communicational, informational and computeristic experiences all in one, permanently connected to said means for the satellite launch pad keyboard, by processing digital data style functions as well as one touch actions through keyboards, permanently connected to said means for the grav-draulics, by producing extreme multi directional movements of the coliseum screens, permanently connected to said means for the digi-sensor, an over all system signaling device that's used to read all system commands from user as well as voice activation, heat signaling response or remotely driven, permanently connected to said means for the buzzy bye system to wake up individuals by way of voice, video images, voice tones and this can be performed by satellite connections allowing system to change with the times, permanently connected to said means for the digital projection grid by viewing images on screen that's transferred through virtual media, animation and communication to wall viewing, permanently connected to said means for the all digital camera probes 5 in 1, through voice activation or use of satellite keys allowing sheer versatility in surveillance, media style projections, videos and filming etc, permanently connected to said means for tell tell indicator to activate a green flashing lamp when system is ok to use, yellow is extreme caution and red is extreme warning of system malfunctioning, permanently connected to said means for the dust shield wiper to wipe clean any debris or substance away from coliseum screens with specialty cleaning interfaces, permanently connected to said means for subject shadowing function to place live moving visual features on hold just as you would an ordinary phone call, permanently connected to said means for the retractable functional keypad by using this device as both a multi digital remote tool and a wireless/cordless extra keyboard all in one feature, and permanently connected to said means for the ear all hearing device to communicate internally and externally with the whole deputy series (et.al) system;
means for system insulated firewall to insulate and keep entire system cool at all times, permanently connected to said means for the arsenal tower to operate all digital integrated operations to be ran smoothly in the most compact form;
means for the digital style voltage transmitter plug to allow multi networking around the home/office or constant networking for mobility, permanently connected to said means for the arsenal tower to operate all digital integrated operations to be ran smoothly in the most compact form;
means for the multi-global style formatting excursion to navigate throughout space, remix movies, multi bounty search, permanently connected to said means for the arsenal tower to operate all digital integrated operations to be ran smoothly in the most compact form;
means for the digital solar chipset to run system without battery or electricity or sun light for the life of the system, permanently connected to said means for the arsenal tower to operate all digital integrated operations to be ran smoothly in the most compact form;
means for the explosive sorter drive to enable user(s) to stack libraries of information constantly, permanently connected to said means for the arsenal tower to operate all digital integrated operations to be ran smoothly in the most compact form;
means for the all digital illuminated usb portability style interface which enables individuals to load ports at a push of a button, also remove ports and enhance support for system, permanently connected to said means for the arsenal tower to operate all digital integrated operations to be ran smoothly in the most compact form;
means for the z:/co-pilot to stack multiple driver in driver formatting an extensive back up for the system, permanently connected to said means for the arsenal tower to operate all digital integrated operations to be ran smoothly in the most compact form;
means for the multiple rom-mobility to perform quadra media duplications stationary or mobilized through pull out capabilities, permanently connected to said means for the arsenal tower to operate all digital integrated operations to be ran smoothly in the most compact form;
means for the mini spectrum port holes function to enable you to be able to watch unlimited images and control communication links through unlimited small windows, relatively connected to said means for the arsenal tower to operate all digital integrated operations to be ran smoothly in the most compact form, and securely connected to said means for the coliseum screens, by watching an all digital, televisual, satellite response, navigational, surveillance, mulitmedia, communicational, informational and computeristic experiences all in one;
means for the virtual aqua display which enables individuals to have an actual or virtual fish exhibit as well as any interior/exterior animated or live display of their choice, securely connected to said means for the arsenal tower to operate all digital integrated operations to be ran smoothly in the most compact form;
means for the deputy series storage unit to store entire deputy series-music cinema et. al system;
means for the retractable keyboard remote to control entire system as a back up remote and back up keyboard for mobilosity with unlimited range; and
means for the index scan to check any and all vital signs including other various forms of medical testing, permanently connected to said means for the arsenal tower to operate all digital integrated operations to be ran smoothly in the most compact form, and detachably connected to said means for the satellite launch pad keyboard, by processing digital data style functions as well as one touch actions through keyboards.

2. The deputy series-music cinema or transfortainment pc (phirst classic) or digi-tasking mobile-cycle devices for maximum digital mobilosity or the digital entertaining pc or transfertainment or transformtainment or the all digital activity center or satellite entertainment mogul or satellite entainment pc (phirst classic) in accordance with claim 1, wherein said means for the ear all hearing device to communicate internally and externally with the whole deputy series (et.al) system comprises a bowed and rounded, flexible duroplastic coating, black felt style ear coverings, plastic style mouth bridge, zero ounces in weight, multiple colors, wireless/cordless ear all hearing device.

3. The deputy series-music cinema or transfortainment pc (phirst classic) or digi-tasking mobile-cycle devices for maximum digital mobilosity or the digital entertaining pc or transfertainment or transformtainment or the all digital activity center or satellite entertainment mogul or satellite entainment pc (phirst classic) in accordance with claim 1, wherein said means for the remotomouse motion on air/sensor propelled. on/off activation and deactivation of a variety of all functions throughout entire system comprises an oval shaped, slideback lid, multiple colors, zero ounces in weight, wireless/cordless remotomouse.

4. The deputy series-music cinema or transfortainment pc (phirst classic) or digi-tasking mobile-cycle devices for maximum digital mobilosity or the digital entertaining pc or transfertainment or transformtainment or the all digital activity center or satellite entertainment mogul or satellite entainment pc (phirst classic) in accordance with claim 1, wherein said means for the retractable functional keypad by using this device as both a multi digital remote tool and a wireless/cordless extra keyboard all in one feature comprises a square shaped, single row of 15 keys, function keys are first main row of keyboard, zero ounces in weight, multiple design, multiple colors retractable functional keypad.

5. The deputy series-music cinema or transfortainment pc (phirst classic) or digi-tasking mobile-cycle devices for maximum digital mobilosity or the digital entertaining pc or transfertainment or transformtainment or the all digital activity center or satellite entertainment mogul or satellite entainment pc (phirst classic) in accordance with claim 1, wherein said means for subject shadowing function to place live moving visual features on hold just as you would an ordinary phone call comprises an oval keys, multiple colors, zero ounces in weight, illuminates, special characters on keys subject shadowing function.

6. The deputy series-music cinema or transfortainment pc (phirst classic) or digi-tasking mobile-cycle devices for maximum digital mobilosity or the digital entertaining pc or transfertainment or transformtainment or the all digital activity center or satellite entertainment mogul or satellite entainment pc (phirst classic) in accordance with claim 1, wherein said means for the dust shield wiper to wipe clean any debris or substance away from coliseum screens with specialty cleaning interfaces comprises a sleek/slender holding clamp, feather/rubber attachment for clamp, zero ounces in weight, multiple colors, illuminates, wireless/detachable dust shield wiper.

7. The deputy series-music cinema or transfortainment pc (phirst classic) or digi-tasking mobile-cycle devices for maximum digital mobilosity or the digital entertaining pc or transfertainment or transformtainment or the all digital activity center or satellite entertainment mogul or satellite entainment pc (phirst classic) in accordance with claim 1, wherein said means for tell tell indicator to activate a green flashing lamp when system is ok to use, yellow is extreme caution and red is extreme warning of system malfunctioning comprises a round, bubble shaped, green, yellow and red flashing lights, internal/external in design, duroplastic coating, illuminate fixture tell tell indicator.

8. The deputy series-music cinema or transfortainment pc (phirst classic) or digi-tasking mobile-cycle devices for maximum digital mobilosity or the digital entertaining pc or transfertainment or transformtainment or the all digital activity center or satellite entertainment mogul or satellite entainment pc (phirst classic) in accordance with claim 1, wherein said means for the all digital camera probes 5 in 1, through voice activation or use of satellite keys allowing sheer versatility in surveillance, media style projections, videos and filming etc comprises a circular, round in shape, embedded in screen panels, multiple colors, zero ounces in weight, duroplastic style lens all digital camera probes 5 in 1.

9. The deputy series-music cinema or transfortainment pc (phirst classic) or digi-tasking mobile-cycle devices for maximum digital mobilosity or the digital entertaining pc or transfertainment or transformtainment or the all digital activity center or satellite entertainment mogul or satellite entainment pc (phirst classic) in accordance with claim 1, wherein said means for the digital projection grid by viewing images on screen that's transferred through virtual media, animation and communication to wall viewing comprises a circular, round shaped, duroplastic, magnified glass, multiple colors, zero ounces in weight, digital lighting digital projection grid.

10. The deputy series-music cinema or transfortainment pc (phirst classic) or digi-tasking mobile-cycle devices for maximum digital mobilosity or the digital entertaining pc or transfertainment or transformtainment or the all digital activity center or satellite entertainment mogul or satellite entainment pc (phirst classic) in accordance with claim 1, wherein said means for the buzzy bye system to wake up individuals by way of voice, video images, voice tones and this can be performed by satellite connections allowing system to change with the times comprises a square shaped panel, multiple digital lighting, zero ounces in weight, image in view area the buzzy bye system.

11. The deputy series-music cinema or transfortainment pc (phirst classic) or digi-tasking mobile-cycle devices for maximum digital mobilosity or the digital entertaining pc or transfertainment or transformtainment or the all digital activity center or satellite entertainment mogul or satellite entainment pc (phirst classic) in accordance with claim 1, wherein said means for the digi-sensor, an over all system signaling device that's used to read all system commands from user as well as voice activation, heat signaling response or remotely driven comprises a circular/round shaped, round fiber glass view window, zero ounces in weight, multiple colors, sensor signal illumination digi-sensor.

12. The deputy series-music cinema or transfortainment pc (phirst classic) or digi-tasking mobile-cycle devices for maximum digital mobilosity or the digital entertaining pc or transfertainment or transformtainment or the all digital activity center or satellite entertainment mogul or satellite entainment pc (phirst classic) in accordance with claim 1, wherein said means for the grav-draulics, by producing extreme multi directional movements of the coliseum screens comprises an oval shaped, semi oval neck/extension, fiber glass coating, zero ounces in weight, multiple colors, circular sensor window grav-draulics.

13. The deputy series-music cinema or transfortainment pc (phirst classic) or digi-tasking mobile-cycle devices for maximum digital mobilosity or the digital entertaining pc or transfertainment or transformtainment or the all digital activity center or satellite entertainment mogul or satellite entainment pc (phirst classic) in accordance with claim 1, wherein said means for the satellite launch pad keyboard, by processing digital data style functions as well as one touch actions through keyboards comprises a square shaped, duroplastic coating, 104 key keyboard, launch pad illuminates, zero ounces in weight, multiple colors, wireless/cordless satellite launch pad keyboard.

14. The deputy series-music cinema or transfortainment pc (phirst classic) or digi-tasking mobile-cycle devices for maximum digital mobilosity or the digital entertaining pc or transfertainment or transformtainment or the all digital activity center or satellite entertainment mogul or satellite entainment pc (phirst classic) in accordance with claim 1, wherein said means for the eye level technology to clinically test any optical conditions comprises a squared key, multiple colors, zero ounces in weight, illuminates, special characters on keys eye level technology.

15. The deputy series-music cinema or transfortainment pc (phirst classic) or digi-tasking mobile-cycle devices for maximum digital mobilosity or the digital entertaining pc or transfertainment or transformtainment or the all digital activity center or satellite entertainment mogul or satellite entainment pc (phirst classic) in accordance with claim 1, wherein said means for the coliseum screens, by watching an all digital, televisual, satellite response, navigational, surveillance, mulitmedia, communicational, informational and computeristic experiences all in one comprises a square shaped, zero ounces in weight, multiple colors, detachable rear perforation, soft squared edges, digital formatted illustrations, digital sensors/cams, repeat performance/reversible coliseum screens.

16. The deputy series-music cinema or transfortainment pc (phirst classic) or digi-tasking mobile-cycle devices for maximum digital mobilosity or the digital entertaining pc or transfertainment or transformtainment or the all digital activity center or satellite entertainment mogul or satellite entainment pc (phirst classic) in accordance with claim 1, wherein said means for indigimation phone system to interact with all forms of touch screen phone communication systems and wireless landline, cell communications for extreme voice over satellite media comprises a square, illuminated, multiple colors, zero ounces in weight, special characters on keys indigimation phone system.

17. The deputy series-music cinema or transfortainment pc (phirst classic) or digi-tasking mobile-cycle devices for maximum digital mobilosity or the digital entertaining pc or transfertainment or transformtainment or the all digital activity center or satellite entertainment mogul or satellite entainment pc (phirst classic) in accordance with claim 1, wherein said means for the digitainment cam to demonstrate all aspects of trick filming and photography comprises a circular round, rubber molding stabilizer, multiple colors, zero ounces in weight, duroplastic lens digitainment cam.

18. The deputy series-music cinema or transfortainment pc (phirst classic) or digi-tasking mobile-cycle devices for maximum digital mobilosity or the digital entertaining pc or transfertainment or transformtainment or the all digital activity center or satellite entertainment mogul or satellite entainment pc (phirst classic) in accordance with claim 1, wherein said means for stay flossy to process multi pre-appointment and pre-examination dental results for system preparation in all digital networking with dental office in a safe and in an extremely sanitized manner comprises a squared, multiple colors, zero ounces in weight, special characters on keys stay flossy.

19. The deputy series-music cinema or transfortainment pc (phirst classic) or digi-tasking mobile-cycle devices for maximum digital mobilosity or the digital entertaining pc or transfertainment or transformtainment or the all digital activity center or satellite entertainment mogul or satellite entainment pc (phirst classic) in accordance with claim 1, wherein said means for the night watchman visual surveillance which is used to allow user(s) to probe very hard to see areas in nearby surroundings, roof tops, alley ways etc comprises a squared shaped, multiple colors, zero ounces in weight, illuminates, special characters on keys night watchman visual surveillance.

20. The deputy series-music cinema or transfortainment pc (phirst classic) or digi-tasking mobile-cycle devices for maximum digital mobilosity or the digital entertaining pc or transfertainment or transformtainment or the all digital activity center or satellite entertainment mogul or satellite entainment pc (phirst classic) in accordance with claim 1, wherein said means for the galaxy viewing feature to allow user(s) to digitally view space from virtually any place in the world on their home system comprises a squared shaped, multiple colors, zero ounces in weight, illuminates, special characters on keys galaxy viewing.

21. The deputy series-music cinema or transfortainment pc (phirst classic) or digi-tasking mobile-cycle devices for maximum digital mobilosity or the digital entertaining pc or transfertainment or transformtainment or the all digital activity center or satellite entertainment mogul or satellite entainment pc (phirst classic) in accordance with claim 1, wherein said means for the major link voicecom system to communicate internally/externally around a variety of large or secluded areas and at extreme distances comprises a squared shaped, multiple colors, zero ounces in weight, illuminates, special characters on keys major link voicecom system.

22. The deputy series-music cinema or transfortainment pc (phirst classic) or digi-tasking mobile-cycle devices for maximum digital mobilosity or the digital entertaining pc or transfertainment or transformtainment or the all digital activity center or satellite entertainment mogul or satellite entainment pc (phirst classic) in accordance with claim 1, wherein said means for the access mobility pilot to accommodate individuals with disabilities comprises a square key, multiple color, zero ounces in weight, illuminates, special characters on keys access mobility pilot.

23. The deputy series-music cinema or transfortainment pc (phirst classic) or digi-tasking mobile-cycle devices for maximum digital mobilosity or the digital entertaining pc or transfertainment or transformtainment or the all digital activity center or satellite entertainment mogul or satellite entainment pc (phirst classic) in accordance with claim 1, wherein said means for the emergency dispatch assistance to communicate with any and all emergency services via transfortainment comprises a square key, multiple colors, zero ounces in weight, illuminates, special characters on keys emergency dispatch assistance.

24. The deputy series-music cinema or transfortainment pc (phirst classic) or digi-tasking mobile-cycle devices for maximum digital mobilosity or the digital entertaining pc or transfertainment or transformtainment or the all digital activity center or satellite entertainment mogul or satellite entainment pc (phirst classic) in accordance with claim 1, wherein said means for the ttm (transfortainment teller machine) to transact all forms of banking as well as creating travel checks, cashier checks or any special banking needs legally and safely comprises a square keys, multiple colors, zero ounces in weight, illuminated, special characters on keys ttm (transfortainment teller machine).

25. The deputy series-music cinema or transfortainment pc (phirst classic) or digi-tasking mobile-cycle devices for maximum digital mobilosity or the digital entertaining pc or transfertainment or transformtainment or the all digital activity center or satellite entertainment mogul or satellite entainment pc (phirst classic) in accordance with claim 1, wherein said means for the system scope to allow user(s) actual hands on/virtual simulation time in testing and dysecting etc comprises a squared shaped, multiple colors, zero ounces in weight, illuminates, special characters on keys system scope.

26. The deputy series-music cinema or transfortainment pc (phirst classic) or digi-tasking mobile-cycle devices for maximum digital mobilosity or the digital entertaining pc or transfertainment or transformtainment or the all digital activity center or satellite entertainment mogul or satellite entainment pc (phirst classic) in accordance with claim 1, wherein said means for the internal/external mic control to enable user(s) to speak into the mics from left or right midway panels of coliseum screens comprises a 3 squiggly lines, multiple colors, zero ounces in weight, small fiber screen covers, illuminates internal/external mic control.

27. The deputy series-music cinema or transfortainment pc (phirst classic) or digi-tasking mobile-cycle devices for maximum digital mobilosity or the digital entertaining pc or transfertainment or transformtainment or the all digital activity center or satellite entertainment mogul or satellite entainment pc (phirst classic) in accordance with claim 1, wherein said means for my flavorite pen to be able to write in mid air without ever touching a surface using laser/ray beam interfaces with screens comprises a slender/sleek, dicast plastic coating, zero ounces in weight, multiple colors, wireless/cordless, illuminates my flavorite pen.

28. The deputy series-music cinema or transfortainment pc (phirst classic) or digi-tasking mobile-cycle devices for maximum digital mobilosity or the digital entertaining pc or transfertainment or transformtainment or the all digital activity center or satellite entertainment mogul or satellite entainment pc (phirst classic) in accordance with claim 1, wherein said means for the t.w.i.n. coustic speakers/air freshener/air purification/air conditioner, by listening to output of all media and communications along with freshening, cleaning and conditioning the air on multiple speed by use of voice activation or remote driven comprises a square shaped, acrylic style coating, zero ounces in weight, multiple colors, wireless/cordless, digital readout t.w.i.n. coustic speakers/air freshener/air purification/air conditioner.

29. The deputy series-music cinema or transfortainment pc (phirst classic) or digi-tasking mobile-cycle devices for maximum digital mobilosity or the digital entertaining pc or transfertainment or transformtainment or the all digital activity center or satellite entertainment mogul or satellite entainment pc (phirst classic) in accordance with claim 1, wherein said means for the multi way transformation card system performing all digital transfers of media and communications comprises a squared shaped, gap in center for transactions, zero ounces in weight, multiple colors, dicast medal coating multi way transformation card system.

30. The deputy series-music cinema or transfortainment pc (phirst classic) or digi-tasking mobile-cycle devices for maximum digital mobilosity or the digital entertaining pc or transfertainment or transformtainment or the all digital activity center or satellite entertainment mogul or satellite entainment pc (phirst classic) in accordance with claim 1, wherein said means for the swipe card system to accurately read and write data to produce magnetized style necessity cards comprises an oval shape heads, two prongs readouts, zero ounces in weight, multiple colors, fiber glass coating, illuminates swipe card system.

31. The deputy series-music cinema or transfortainment pc (phirst classic) or digi-tasking mobile-cycle devices for maximum digital mobilosity or the digital entertaining pc or transfertainment or transformtainment or the all digital activity center or satellite entertainment mogul or satellite entainment pc (phirst classic) in accordance with claim 1, wherein said means for the arsenal tower to operate all digital integrated operations to be ran smoothly in the most compact form comprises a square shaped, flat/standard in size, zero ounces in weight, multiple colors, digital, wireless/cordless, illuminates arsenal tower.

32. The deputy series-music cinema or transfortainment pc (phirst classic) or digi-tasking mobile-cycle devices for maximum digital mobilosity or the digital entertaining pc or transfertainment or transformtainment or the all digital activity center or satellite entertainment mogul or satellite entainment pc (phirst classic) in accordance with claim 1, wherein said means for system insulated firewall to insulate and keep entire system cool at all times comprises a squared, multi cooled colors, zero ounces in weight system insulated firewall.

33. The deputy series-music cinema or transfortainment pc (phirst classic) or digi-tasking mobile-cycle devices for maximum digital mobilosity or the digital entertaining pc or transfertainment or transformtainment or the all digital activity center or satellite entertainment mogul or satellite entainment pc (phirst classic) in accordance with claim 1, wherein said means for the digital style voltage transmitter plug to allow multi networking around the home/office or constant networking for mobility comprises a squared key, multiple colors, zero ounces in weight, illuminates, special characters on keys digital style voltage transmitter plug.

34. The deputy series-music cinema or transfortainment pc (phirst classic) or digi-tasking mobile-cycle devices for maximum digital mobilosity or the digital entertaining pc or transfertainment or transformtainment or the all digital activity center or satellite entertainment mogul or satellite entainment pc (phirst classic) in accordance with claim 1, wherein said means for the multi-global style formatting excursion to navigate throughout space, remix movies, multi bounty search comprises a circular, flat, multi iluminated colors, zero ounces in weight, invisible, adhesive coating multi-global style formatting excursion.

35. The deputy series-music cinema or transfortainment pc (phirst classic) or digi-tasking mobile-cycle devices for maximum digital mobilosity or the digital entertaining pc or transfertainment or transformtainment or the all digital activity center or satellite entertainment mogul or satellite entainment pc (phirst classic) in accordance with claim 1, wherein said means for the digital solar chipset to run system without battery or electricity or sun light for the life of the system comprises a circular and flat, multiple color interfaces, zero ounces in weight, illuminating components digital solar chipset.

36. The deputy series-music cinema or transfortainment pc (phirst classic) or digi-tasking mobile-cycle devices for maximum digital mobilosity or the digital entertaining pc or transfertainment or transformtainment or the all digital activity center or satellite entertainment mogul or satellite entainment pc (phirst classic) in accordance with claim 1, wherein said means for the explosive sorter drive to enable user(s) to stack libraries of information constantly comprises a square and flat, multiple illuminated colors, illuminated wiring, zero ounces in weight, multiple indicator lights, glo-wiring explosive sorter drive.

37. The deputy series-music cinema or transfortainment pc (phirst classic) or digi-tasking mobile-cycle devices for maximum digital mobilosity or the digital entertaining pc or transfertainment or transformtainment or the all digital activity center or satellite entertainment mogul or satellite entainment pc (phirst classic) in accordance with claim 1, wherein said means for the all digital illuminated usb portability style interface which enables individuals to load ports at a push of a button, also remove ports and enhance support for system comprises a square, multiple color circuitry, zero ounces in weight, illuminates all digital illuminated usb portability style interface.

38. The deputy series-music cinema or transfortainment pc (phirst classic) or digi-tasking mobile-cycle devices for maximum digital mobilosity or the digital entertaining pc or transfertainment or transformtainment or the all digital activity center or satellite entertainment mogul or satellite entainment pc (phirst classic) in accordance with claim 1, wherein said means for the z:/co-pilot to stack multiple driver in driver formatting an extensive back up for the system comprises a flat and squared, multiple illuminating colors, zero ounces in weight, illuminated wiring, special character on key z:/co-pilot.

39. The deputy series-music cinema or transfortainment pc (phirst classic) or digi-tasking mobile-cycle devices for maximum digital mobilosity or the digital entertaining pc or transfertainment or transformtainment or the all digital activity center or satellite entertainment mogul or satellite entainment pc (phirst classic) in accordance with claim 1, wherein said means for the multiple rom-mobility to perform quadra media duplications stationary or mobilized through pull out capabilities comprises a square, multiple colors, zero ounces in weight, illuminated circuitry, illuminated indicator lights, special character on key multiple rom-mobility.

40. The deputy series-music cinema or transfortainment pc (phirst classic) or digi-tasking mobile-cycle devices for maximum digital mobilosity or the digital entertaining pc or transfertainment or transformtainment or the all digital activity center or satellite entertainment mogul or satellite entainment pc (phirst classic) in accordance with claim 1, wherein said means for the mini spectrum port holes function to enable you to be able to watch unlimited images and control communication links through unlimited small windows comprises a multiple shapes, multiple colors, zero ounces in weight, special characters on key, digital, special character on key, illuminates the mini spectrum port holes function.

41. The deputy series-music cinema or transfortainment pc (phirst classic) or digi-tasking mobile-cycle devices for maximum digital mobilosity or the digital entertaining pc or transfertainment or transformtainment or the all digital activity center or satellite entertainment mogul or satellite entainment pc (phirst classic) in accordance with claim 1, wherein said means for the virtual aqua display which enables individuals to have an actual or virtual fish exhibit as well as any interior/exterior animated or live display of their choice comprises a multiple shapes, multiple colors, zero ounces in weight, all virtual, all digital, special character on key, illuminates virtual aqua display.

42. The deputy series-music cinema or transfortainment pc (phirst classic) or digi-tasking mobile-cycle devices for maximum digital mobilosity or the digital entertaining pc or transfertainment or transformtainment or the all digital activity center or satellite entertainment mogul or satellite entainment pc (phirst classic) in accordance with claim 1, wherein said means for the deputy series storage unit to store entire deputy series-music cinema et. al system comprises a square shaped, vinyl sidings, multiple colors, zero ounces in weight, dicast fiber glass wheels, dicast handles, illuminates, fiber glass door covering, wood grain/oak, duroplastic surface interface deputy series storage unit.

43. The deputy series-music cinema or transfortainment pc (phirst classic) or digi-tasking mobile-cycle devices for maximum digital mobilosity or the digital entertaining pc or transfertainment or transformtainment or the all digital activity center or satellite entertainment mogul or satellite entainment pc (phirst classic) in accordance with claim 1, wherein said means for the retractable keyboard remote to control entire system as a back up remote and back up keyboard for mobilosity with unlimited range comprises an oval top and rectangle based, multiple colors, zero ounces in weight, retractable, illuminates, square buttons, see through retractable keyboard remote.

44. The deputy series-music cinema or transfortainment pc (phirst classic) or digi-tasking mobile-cycle devices for maximum digital mobilosity or the digital entertaining pc or transfertainment or transformtainment or the all digital activity center or satellite entertainment mogul or satellite entainment pc (phirst classic) in accordance with claim 1, wherein said means for the index scan to check any and all vital signs including other various forms of medical testing comprises a squared key, multiple color, zero ounces in weight, illuminates, special characters on keys index scan.

45. A deputy series-music cinema or transfortainment pc (phirst classic) or digi-tasking mobile-cycle devices for maximum digital mobilosity or the digital entertaining pc or transfertainment or transformtainment or the all digital activity center or satellite entertainment mogul or satellite entainment pc (phirst classic) for retrieving globally and displaying maximum digital media/communications in all forms possible, comprising:
a bowed and rounded, flexible duroplastic coating, black felt style ear coverings, plastic style mouth bridge, zero ounces in weight, multiple colors, wireless/cordless ear all hearing device, for the ear all hearing device to communicate internally and externally with the whole deputy series (et.al) system;
an oval shaped, slideback lid, multiple colors, zero ounces in weight, wireless/cordless remotomouse, for the remotomouse motion on air/sensor propelled. on/off activation and deactivation of a variety of all functions throughout entire system;
a square shaped, single row of 15 keys, function keys are first main row of keyboard, zero ounces in weight, multiple design, multiple colors retractable functional keypad, for the retractable functional keypad by using this device as both a multi digital remote tool and a wireless/cordless extra keyboard all in one feature, sealingly connected to said Remotomouse;
an oval keys, multiple colors, zero ounces in weight, illuminates, special characters on keys subject shadowing function, for subject shadowing function to place live moving visual features on hold just as you would an ordinary phone call, actively connected to said Remotomouse;
a sleek/slender holding clamp, feather/rubber attachment for clamp, zero ounces in weight, multiple colors, illuminates, wireless/detachable dust shield wiper, for the dust shield wiper to wipe clean any debris or substance away from coliseum screens with specialty cleaning interfaces;
a round, bubble shaped, green, yellow and red flashing lights, internal/external in design, duroplastic coating, illuminate fixture tell tell indicator, for tell tell indicator to activate a green flashing lamp when system is ok to use, yellow is extreme caution and red is extreme warning of system malfunctioning;
a circular, round in shape, embedded in screen panels, multiple colors, zero ounces in weight, duroplastic style lens all digital camera probes 5 in 1, for the all digital camera probes 5 in 1, through voice activation or use of satellite keys allowing sheer versatility in surveillance, media style projections, videos and filming etc;
a circular, round shaped, duroplastic, magnified glass, multiple colors, zero ounces in weight, digital lighting digital projection grid, for the digital projection grid by viewing images on screen that's transferred through virtual media, animation and communication to wall viewing;
a square shaped panel, multiple digital lighting, zero ounces in weight, image in view area the buzzy bye system, for the buzzy bye system to wake up individuals by way of voice, video images, voice tones and this can be performed by satellite connections allowing system to change with the times;
a circular/round shaped, round fiber glass view window, zero ounces in weight, multiple colors, sensor signal illumination digi-sensor, for the digi-sensor, an over all system signaling device that's used to read all system commands from user as well as voice activation, heat signaling response or remotely driven;
an oval shaped, semi oval neck/extension, fiber glass coating, zero ounces in weight, multiple colors, circular sensor window grav-draulics, for the grav-draulics, by producing extreme multi directional movements of the coliseum screens;
a square shaped, duroplastic coating, 104 key keyboard, launch pad illuminates, zero ounces in weight, multiple colors, wireless/cordless satellite launch pad keyboard, for the satellite launch pad keyboard, by processing digital data style functions as well as one touch actions through keyboards;
a squared key, multiple colors, zero ounces in weight, illuminates, special characters on keys eye level technology, for the eye level technology to clinically test any optical conditions;
a square shaped, zero ounces in weight, multiple colors, detachable rear perforation, soft squared edges, digital formatted illustrations, digital sensors/cams, repeat performance/reversible coliseum screens, for the coliseum screens, by watching an all digital, televisual, satellite response, navigational, surveillance, mulitmedia, communicational, informational and computeristic experiences all in one, swivelly connected to said Grav-Draulics, snugly connected to said Digi-Sensor, snugly connected to said Digital Projection Grid, snugly connected to said All Digital Camera Probes 5 in 1, engagingly connected to said Tell Tell Indicator, and rotationally connected to said Dust Shield Wiper;
a square, illuminated, multiple colors, zero ounces in weight, special characters on keys indigimation phone system, for indigimation phone system to interact with all forms of touch screen phone communication systems and wireless landline, cell communications for extreme voice over satellite media, remotely connected to said Satellite Launch Pad Keyboard;
a circular round, rubber molding stabilizer, multiple colors, zero ounces in weight, duroplastic lens digitainment cam, for the digitainment cam to demonstrate all aspects of trick filming and photography, snugly connected to said Coliseum Screens;
a squared, multiple colors, zero ounces in weight, special characters on keys stay flossy, for stay flossy to process multi pre-appointment and pre-examination dental results for system preparation in all digital networking with dental office in a safe and in an extremely sanitized manner, remotely connected to said Satellite Launch Pad Keyboard;
a squared shaped, multiple colors, zero ounces in weight, illuminates, special characters on keys night watchman visual surveillance, for the night watchman visual surveillance which is used to allow user(s) to probe very hard to see areas in nearby surroundings, roof tops, alley ways etc, remotely connected to said Satellite Launch Pad Keyboard;
a squared shaped, multiple colors, zero ounces in weight, illuminates, special characters on keys galaxy viewing, for the galaxy viewing feature to allow user(s) to digitally view space from virtually any place in the world on their home system, remotely connected to said Satellite Launch Pad Keyboard;
a squared shaped, multiple colors, zero ounces in weight, illuminates, special characters on keys major link voicecom system, for the major link voicecom system to communicate internally/externally around a variety of large or secluded areas and at extreme distances, remotely connected to said Satellite Launch Pad Keyboard;
a square key, multiple color, zero ounces in weight, illuminates, special characters on keys access mobility pilot, for the access mobility pilot to accommodate individuals with disabilities, remotely connected to said Satellite Launch Pad Keyboard;
a square key, multiple colors, zero ounces in weight, illuminates, special characters on keys emergency dispatch assistance, for the emergency dispatch assistance to communicate with any and all emergency services via transfortainment, remotely connected to said Satellite Launch Pad Keyboard;
a square keys, multiple colors, zero ounces in weight, illuminated, special characters on keys ttm (transfortainment teller machine), for the ttm (transfortainment teller machine) to transact all forms of banking as well as creating travel checks, cashier checks or any special banking needs legally and safely, remotely connected to said Satellite Launch Pad Keyboard;
a squared shaped, multiple colors, zero ounces in weight, illuminates, special characters on keys system scope, for the system scope to allow user(s) actual hands on/virtual simulation time in testing and dysecting etc, snugly connected to said Satellite Launch Pad Keyboard;
a 3 squiggly lines, multiple colors, zero ounces in weight, small fiber screen covers, illuminates internal/external mic control, for the internal/external mic control to enable user(s) to speak into the mics from left or right midway panels of coliseum screens, rigidly connected to said Satellite Launch Pad Keyboard;
a slender/sleek, dicast plastic coating, zero ounces in weight, multiple colors, wireless/cordless, illuminates my flavorite pen, for my flavorite pen to be able to write in mid air without ever touching a surface using laser/ray beam interfaces with screens;
a square shaped, acrylic style coating, zero ounces in weight, multiple colors, wireless/cordless, digital readout t.w.i.n. coustic speakers/air freshener/air purification/air conditioner, for the t.w.i.n. coustic speakers/air freshener/air purification/air conditioner, by listening to output of all media and communications along with freshening, cleaning and conditioning the air on multiple speed by use of voice activation or remote driven;
a squared shaped, gap in center for transactions, zero ounces in weight, multiple colors, dicast medal coating multi way transformation card system, for the multi way transformation card system performing all digital transfers of media and communications;
an oval shape heads, two prongs readouts, zero ounces in weight, multiple colors, fiber glass coating, illuminates swipe card system, for the swipe card system to accurately read and write data to produce magnetized style necessity cards;
a square shaped, flat/standard in size, zero ounces in weight, multiple colors, digital, wireless/cordless, illuminates arsenal tower, for the arsenal tower to operate all digital integrated operations to be ran smoothly in the most compact form, permanently connected to said T.W.I.N. Coustic Speakers/Air Freshener/Air Purification/Air Conditioner, permanently connected to said My Flavorite Pen, permanently connected to said Internal/External Mic Control, permanently connected to said System Scope, permanently connected to said TTM (Transfortainment Teller Machine), permanently connected to said Emergency Dispatch Assistance, permanently connected to said Access Mobility Pilot, permanently connected to said Major Link Voicecom System, permanently connected to said Galaxy Viewing, permanently connected to said Night Watchman Visual Surveillance, permanently connected to said Stay Flossy, permanently connected to said Digitainment Cam, permanently connected to said Indigimation Phone System, permanently connected to said Coliseum Screens, permanently connected to said Satellite Launch Pad Keyboard, permanently connected to said Grav-Draulics, permanently connected to said Digi-Sensor, permanently connected to said The Buzzy Bye System, permanently connected to said Digital Projection Grid, permanently connected to said All Digital Camera Probes 5 in 1, permanently connected to said Tell Tell Indicator, permanently connected to said Dust Shield Wiper, permanently connected to said Subject Shadowing Function, permanently connected to said Retractable Functional Keypad, and permanently connected to said Ear All Hearing Device;
a squared, multi cooled colors, zero ounces in weight system insulated firewall, for system insulated firewall to insulate and keep entire system cool at all times, permanently connected to said Arsenal Tower;
a squared key, multiple colors, zero ounces in weight, illuminates, special characters on keys digital style voltage transmitter plug, for the digital style voltage transmitter plug to allow multi networking around the home/office or constant networking for mobility, permanently connected to said Arsenal Tower;
a circular, flat, multi iluminated colors, zero ounces in weight, invisible, adhesive coating multi-global style formatting excursion, for the multi-global style formatting excursion to navigate throughout space, remix movies, multi bounty search, permanently connected to said Arsenal Tower;
a circular and flat, multiple color interfaces, zero ounces in weight, illuminating components digital solar chipset, for the digital solar chipset to run system without battery or electricity or sun light for the life of the system, permanently connected to said Arsenal Tower;
a square and flat, multiple illuminated colors, illuminated wiring, zero ounces in weight, multiple indicator lights, glo-wiring explosive sorter drive, for the explosive sorter drive to enable user(s) to stack libraries of information constantly, permanently connected to said Arsenal Tower;
a square, multiple color circuitry, zero ounces in weight, illuminates all digital illuminated usb portability style interface, for the all digital illuminated usb portability style interface which enables individuals to load ports at a push of a button, also remove ports and enhance support for system, permanently connected to said Arsenal Tower;
a flat and squared, multiple illuminating colors, zero ounces in weight, illuminated wiring, special character on key z:/co-pilot, for the z:/ co-pilot to stack multiple driver in driver formatting an extensive back up for the system, permanently connected to said Arsenal Tower;
a square, multiple colors, zero ounces in weight, illuminated circuitry, illuminated indicator lights, special character on key multiple rom-mobility, for the multiple rom-mobility to perform quadra media duplications stationary or mobilized through pull out capabilities, permanently connected to said Arsenal Tower;
a multiple shapes, multiple colors, zero ounces in weight, special characters on key, digital, special character on key, illuminates the mini spectrum port holes function, for the mini spectrum port holes function to enable you to be able to watch unlimited images and control communication links through unlimited small windows, relatively connected to said Arsenal Tower, and securely connected to said Coliseum Screens;
a multiple shapes, multiple colors, zero ounces in weight, all virtual, all digital, special character on key, illuminates virtual aqua display, for the virtual aqua display which enables individuals to have an actual or virtual fish exhibit as well as any interior/exterior animated or live display of their choice, securely connected to said Arsenal Tower;
a square shaped, vinyl sidings, multiple colors, zero ounces in weight, dicast fiber glass wheels, dicast handles, illuminates, fiber glass door covering, wood grain/oak, duroplastic surface interface deputy series storage unit, for the deputy series storage unit to store entire deputy series-music cinema et. al system;
an oval top and rectangle based, multiple colors, zero ounces in weight, retractable, illuminates, square buttons, see through retractable keyboard remote, for the retractable keyboard remote to control entire system as a back up remote and back up keyboard for mobilosity with unlimited range; and
a squared key, multiple color, zero ounces in weight, illuminates, special characters on keys index scan, for the index scan to check any and all vital signs including other various forms of medical testing, permanently connected to said Arsenal Tower, and detachably connected to said Satellite Launch Pad Keyboard.

46. A deputy series-music cinema or transfortainment pc (phirst classic) or digi-tasking mobile-cycle devices for maximum digital mobilosity or the digital entertaining pc or transfertainment or transformtainment or the all digital activity center or satellite entertainment mogul or satellite entainment pc (phirst classic) for retrieving globally and displaying maximum digital media/communications in all forms possible, comprising:
a bowed and rounded, flexible duroplastic coating, black felt style ear coverings, plastic style mouth bridge, zero ounces in weight, multiple colors, wireless/cordless ear all hearing device, for the ear all hearing device to communicate internally and externally with the whole deputy series (et.al) system;
an oval shaped, slideback lid, multiple colors, zero ounces in weight, wireless/cordless remotomouse, for the remotomouse motion on air/sensor propelled. on/off activation and deactivation of a variety of all functions throughout entire system;
a square shaped, single row of 15 keys, function keys are first main row of keyboard, zero ounces in weight, multiple design, multiple colors retractable functional keypad, for the retractable functional keypad by using this device as both a multi digital remote tool and a wireless/cordless extra keyboard all in one feature, sealingly connected to said Remotomouse;
an oval keys, multiple colors, zero ounces in weight, illuminates, special characters on keys subject shadowing function, for subject shadowing function to place live moving visual features on hold just as you would an ordinary phone call, actively connected to said Remotomouse;
a sleek/slender holding clamp, feather/rubber attachment for clamp, zero ounces in weight, multiple colors, illuminates, wireless/detachable dust shield wiper, for the dust shield wiper to wipe clean any debris or substance away from coliseum screens with specialty cleaning interfaces;
a round, bubble shaped, green, yellow and red flashing lights, internal/external in design, duroplastic coating, illuminate fixture tell tell indicator, for tell tell indicator to activate a green flashing lamp when system is ok to use, yellow is extreme caution and red is extreme warning of system malfunctioning;
a circular, round in shape, embedded in screen panels, multiple colors, zero ounces in weight, duroplastic style lens all digital camera probes 5 in 1, for the all digital camera probes 5 in 1, through voice activation or use of satellite keys allowing sheer versatility in surveillance, media style projections, videos and filming etc;
a circular, round shaped, duroplastic, magnified glass, multiple colors, zero ounces in weight, digital lighting digital projection grid, for the digital projection grid by viewing images on screen that's transferred through virtual media, animation and communication to wall viewing;
a square shaped panel, multiple digital lighting, zero ounces in weight, image in view area the buzzy bye system, for the buzzy bye system to wake up individuals by way of voice, video images, voice tones and this can be performed by satellite connections allowing system to change with the times;
a circular/round shaped, round fiber glass view window, zero ounces in weight, multiple colors, sensor signal illumination digi-sensor, for the digi-sensor, an over all system signaling device that's used to read all system commands from user as well as voice activation, heat signaling response or remotely driven;
an oval shaped, semi oval neck/extension, fiber glass coating, zero ounces in weight, multiple colors, circular sensor window grav-draulics, for the grav-draulics, by producing extreme multi directional movements of the coliseum screens;
a square shaped, duroplastic coating, 104 key keyboard, launch pad illuminates, zero ounces in weight, multiple colors, wireless/cordless satellite launch pad keyboard, for the satellite launch pad keyboard, by processing digital data style functions as well as one touch actions through keyboards;
a squared key, multiple colors, zero ounces in weight, illuminates, special characters on keys eye level technology, for the eye level technology to clinically test any optical conditions;
a square shaped, zero ounces in weight, multiple colors, detachable rear perforation, soft squared edges, digital formatted illustrations, digital sensors/cams, repeat performance/reversible coliseum screens, for the coliseum screens, by watching an all digital, televisual, satellite response, navigational, surveillance, mulitmedia, communicational, informational and computeristic experiences all in one, swivelly connected to said Grav-Draulics, snugly connected to said Digi-Sensor, snugly connected to said Digital Projection Grid, snugly connected to said All Digital Camera Probes 5 in 1, engagingly connected to said Tell Tell Indicator, and rotationally connected to said Dust Shield Wiper;
a square, illuminated, multiple colors, zero ounces in weight, special characters on keys indigimation phone system, for indigimation phone system to interact with all forms of touch screen phone communication systems and wireless landline, cell communications for extreme voice over satellite media, remotely connected to said Satellite Launch Pad Keyboard;
a circular round, rubber molding stabilizer, multiple colors, zero ounces in weight, duroplastic lens digitainment cam, for the digitainment cam to demonstrate all aspects of trick filming and photography, snugly connected to said Coliseum Screens;
a squared, multiple colors, zero ounces in weight, special characters on keys stay flossy, for stay flossy to process multi pre-appointment and pre-examination dental results for system preparation in all digital networking with dental office in a safe and in an extremely sanitized manner, remotely connected to said Satellite Launch Pad Keyboard;
a squared shaped, multiple colors, zero ounces in weight, illuminates, special characters on keys night watchman visual surveillance, for the night watchman visual surveillance which is used to allow user(s) to probe very hard to see areas in nearby surroundings, roof tops, alley ways etc, remotely connected to said Satellite Launch Pad Keyboard;
a squared shaped, multiple colors, zero ounces in weight, illuminates, special characters on keys galaxy viewing, for the galaxy viewing feature to allow user(s) to digitally view space from virtually any place in the world on their home system, remotely connected to said Satellite Launch Pad Keyboard;
a squared shaped, multiple colors, zero ounces in weight, illuminates, special characters on keys major link voicecom system, for the major link voicecom system to communicate internally/externally around a variety of large or secluded areas and at extreme distances, remotely connected to said Satellite Launch Pad Keyboard;
a square key, multiple color, zero ounces in weight, illuminates, special characters on keys access mobility pilot, for the access mobility pilot to accommodate individuals with disabilities, remotely connected to said Satellite Launch Pad Keyboard;
a square key, multiple colors, zero ounces in weight, illuminates, special characters on keys emergency dispatch assistance, for the emergency dispatch assistance to communicate with any and all emergency services via transfortainment, remotely connected to said Satellite Launch Pad Keyboard;
a square keys, multiple colors, zero ounces in weight, illuminated, special characters on keys ttm (transfortainment teller machine), for the ttm (transfortainment teller machine) to transact all forms of banking as well as creating travel checks, cashier checks or any special banking needs legally and safely, remotely connected to said Satellite Launch Pad Keyboard;
a squared shaped, multiple colors, zero ounces in weight, illuminates, special characters on keys system scope, for the system scope to allow user(s) actual hands on/virtual simulation time in testing and dysecting etc, snugly connected to said Satellite Launch Pad Keyboard;
a 3 squiggly lines, multiple colors, zero ounces in weight, small fiber screen covers, illuminates internal/external mic control, for the internal/external mic control to enable user(s) to speak into the mics from left or right midway panels of coliseum screens, rigidly connected to said Satellite Launch Pad Keyboard;
a slender/sleek, dicast plastic coating, zero ounces in weight, multiple colors, wireless/cordless, illuminates my flavorite pen, for my flavorite pen to be able to write in mid air without ever touching a surface using laser/ray beam interfaces with screens;
a square shaped, acrylic style coating, zero ounces in weight, multiple colors, wireless/cordless, digital readout t.w.i.n. coustic speakers/air freshener/air purification/air conditioner, for the t.w.i.n. coustic speakers/air freshener/air purification/air conditioner, by listening to output of all media and communications along with freshening, cleaning and conditioning the air on multiple speed by use of voice activation or remote driven;
a squared shaped, gap in center for transactions, zero ounces in weight, multiple colors, dicast medal coating multi way transformation card system, for the multi way transformation card system performing all digital transfers of media and communications;
an oval shape heads, two prongs readouts, zero ounces in weight, multiple colors, fiber glass coating, illuminates swipe card system, for the swipe card system to accurately read and write data to produce magnetized style necessity cards;
a square shaped, flat/standard in size, zero ounces in weight, multiple colors, digital, wireless/cordless, illuminates arsenal tower, for the arsenal tower to operate all digital integrated operations to be ran smoothly in the most compact form, permanently connected to said T.W.I.N. Coustic Speakers/Air Freshener/Air Purification/Air Conditioner, permanently connected to said My Flavorite Pen, permanently connected to said Internal/External Mic Control, permanently connected to said System Scope, permanently connected to said TTM (Transfortainment Teller Machine), permanently connected to said Emergency Dispatch Assistance, permanently connected to said Access Mobility Pilot, permanently connected to said Major Link Voicecom System, permanently connected to said Galaxy Viewing, permanently connected to said Night Watchman Visual Surveillance, permanently connected to said Stay Flossy, permanently connected to said Digitainment Cam, permanently connected to said Indigimation Phone System, permanently connected to said Coliseum Screens, permanently connected to said Satellite Launch Pad Keyboard, permanently connected to said Grav-Draulics, permanently connected to said Digi-Sensor, permanently connected to said The Buzzy Bye System, permanently connected to said Digital Projection Grid, permanently connected to said All Digital Camera Probes 5 in 1, permanently connected to said Tell Tell Indicator, permanently connected to said Dust Shield Wiper, permanently connected to said Subject Shadowing Function, permanently connected to said Retractable Functional Keypad, and permanently connected to said Ear All Hearing Device;
a squared, multi cooled colors, zero ounces in weight system insulated firewall, for system insulated firewall to insulate and keep entire system cool at all times, permanently connected to said Arsenal Tower;
a squared key, multiple colors, zero ounces in weight, illuminates, special characters on keys digital style voltage transmitter plug, for the digital style voltage transmitter plug to allow multi networking around the home/office or constant networking for mobility, permanently connected to said Arsenal Tower;
a circular, flat, multi iluminated colors, zero ounces in weight, invisible, adhesive coating multi-global style formatting excursion, for the multi-global style formatting excursion to navigate throughout space, remix movies, multi bounty search, permanently connected to said Arsenal Tower;
a circular and flat, multiple color interfaces, zero ounces in weight, illuminating components digital solar chipset, for the digital solar chipset to run system without battery or electricity or sun light for the life of the system, permanently connected to said Arsenal Tower;
a square and flat, multiple illuminated colors, illuminated wiring, zero ounces in weight, multiple indicator lights, glo-wiring explosive sorter drive, for the explosive sorter drive to enable user(s) to stack libraries of information constantly, permanently connected to said Arsenal Tower;
a square, multiple color circuitry, zero ounces in weight, illuminates all digital illuminated usb portability style interface, for the all digital illuminated usb portability style interface which enables individuals to load ports at a push of a button, also remove ports and enhance support for system, permanently connected to said Arsenal Tower;
a flat and squared, multiple illuminating colors, zero ounces in weight, illuminated wiring, special character on key z:/co-pilot, for the z:/ co-pilot to stack multiple driver in driver formatting an extensive back up for the system, permanently connected to said Arsenal Tower;
a square, multiple colors, zero ounces in weight, illuminated circuitry, illuminated indicator lights, special character on key multiple rom-mobility, for the multiple rom-mobility to perform quadra media duplications stationary or mobilized through pull out capabilities, permanently connected to said Arsenal Tower;
a multiple shapes, multiple colors, zero ounces in weight, special characters on key, digital, special character on key, illuminates the mini spectrum port holes function, for the mini spectrum port holes function to enable you to be able to watch unlimited images and control communication links through unlimited small windows, relatively connected to said Arsenal Tower, and securely connected to said Coliseum Screens;
a multiple shapes, multiple colors, zero ounces in weight, all virtual, all digital, special character on key, illuminates virtual aqua display, for the virtual aqua display which enables individuals to have an actual or virtual fish exhibit as well as any interior/exterior animated or live display of their choice, securely connected to said Arsenal Tower;
a square shaped, vinyl sidings, multiple colors, zero ounces in weight, dicast fiber glass wheels, dicast handles, illuminates, fiber glass door covering, wood grain/oak, duroplastic surface interface deputy series storage unit, for the deputy series storage unit to store entire deputy series-music cinema et. al system;
an oval top and rectangle based, multiple colors, zero ounces in weight, retractable, illuminates, square buttons, see through retractable keyboard remote, for the retractable keyboard remote to control entire system as a back up remote and back up keyboard for mobilosity with unlimited range; and
a squared key, multiple color, zero ounces in weight, illuminates, special characters on keys index scan, for the index scan to check any and all vital signs including other various forms of medical testing, permanently connected to said Arsenal Tower, and detachably connected to said Satellite Launch Pad Keyboard.
